(19) United States
(12) Patent Application Publication
(10) Pub. No.: US 2004/0119814 A1
(43) Pub. Date: Jun. 24, 2004

(54) Video conferencing system and method

(76) Inventors: Allister B. Clisham, San Diego, CA (US); Han T. Lam, San Diego, CA (US); Balaji Lakshmanan, San Diego, CA (US); Dexiang Edward Luo, San Diego, CA (US); Praveen Kumar, San Diego, CA (US); Mehran Erfani, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/327,038

(22) Filed: Dec. 20, 2002

(51) Int. Cl. H04N 7/14

(52) U.S. Cl. 348/14.08; 348/14.09

(57) ABSTRACT

A high quality video conference system enables remote video conferencing over wireless communication links. A portable client device is configured to capture video and audio streams, encode them, and transmit them to a remote client device using a wireless communication link. Multiple video coding algorithms can be implemented in the client device and one of the algorithms chosen for a particular video conference session. One or more destination devices can simultaneously video conference with a client device. Multiple servers manage the high speed communication network. The servers authenticate users and manage video conference sessions, including the initiation and termination of sessions.

### BACKGROUND OF THE INVENTION

1. Field of the Invention

The invention relates to the field of electronic communications. More particularly, the invention relates to the field of video conferencing.

2. Description of the Related Art

Communication systems, such as a telephone system, enable voice and data communications to remote locations. The expansion and availability of telephone systems have allowed for mass adoption of the services provided by the system. A user of the system is associated with a telephone number, which may be analogous to a network address. The telephone number of a desired remote destination device may be entered at a local phone. The local phone may then be connected to the destination device using the telephone system. However, the bandwidth available to a single telephone link is limited. Because of this bandwidth limitation, communications across a telephone link are often limited to voice communications or low data rate communications. Unfortunately, low bandwidth voice communications or low data rate communications are often inadequate for many communications applications. For example, there may be visual information that needs to be sent in a short period of time, or the visual information may be dynamic, and the dynamic nature of the visual information may need to be transmitted to a remote location in substantially real time.

One such application requiring transmission of dynamic visual information to remote devices is video conferencing. In a video conferencing application, video and audio information are captured at a local device and transmitted to a remote device where the video and audio are reproduced. Simultaneously, video and audio information are captured at the remote device and transmitted to the local device to be reproduced. The video and audio information from each device must be captured, transmitted, and then reproduced at the receiving device. This process should also be performed with low latency between the initial capture and the subsequent reproduction in order to present a quality of communications that duplicates a local conversation.

Some presently available video conferencing systems attempt to adapt video conferencing applications to low bandwidth legacy systems, such as telephone systems. However, such systems suffer from the extremely limited amount of bandwidth available in a telephone communications link compared to the bandwidth required for a quality video connection.

Video conferencing systems that run on desktop or portable computers that use the Internet as a communications network are also available. However, the video and audio quality in the Internet based video conferencing systems are still not of very high quality and may suffer from the fluctuating bandwidth available to such applications. The available bandwidth fluctuates based on the loading of the network. Thus, a heavily loaded network may not provide sufficient bandwidth to maintain a quality video conferencing connection. Additionally, the video coding algorithms used in the Internet based video conferencing systems are typically low bit rate algorithms designed for communications over low bandwidth links. A typical video conference application operating in an Internet communication system supports video having a resolution of 320×240 and 15 frames per second. The video stream can be implemented using a H.263+ video codec using a 128 kbps internet connection. However, this is a very low quality video signal. The low number of frames per second results in a choppy display image giving rise to a strobed effect. Additionally, the video resolution is very low. Thus, this quality of video service is not satisfactory for many applications, such as distance learning or business conferences.

Therefore, it is desirable to have a video conference system that is able to provide high quality video and audio to users of the system. Additionally, the system should enable one or more parties to be connected to the same video conference without the additional parties resulting in a degradation of the video or audio quality of the video conference. Additionally, it is desirable for the client devices to be portable such that a user is able to initiate a video conference from any location.

### SUMMARY OF THE INVENTION

In general, embodiments of the invention can include a high quality video conference system that enables remote video conferencing over wireless communication links. A local client device is configured to capture video and audio streams, encode them, packetize them, and transmit them to a remote client device using a wireless communication link. Multiple video and audio coding algorithms can be implemented in the client device with one of the algorithms selected for a particular video conference session. One or more destination devices can simultaneously video conference with a client device. There are servers that interface with the client devices over the wireless high speed communication network. The servers authenticate users and manage video conference sessions, including the initiation and termination of sessions.

In one aspect, a video conference system includes a network having a wireless access point. The network interfaces with a plurality of client devices, where at least one of the plurality of client devices is in communication with the network using a wireless communication link to the access point. The system also includes a billing system management application (BSMA) server configured to authenticate the plurality of client devices, manage call requests from a source device to a destination device, and determine a bill for a video conference session between the source device and the destination device.

In another aspect, a client device is configured to provide video conferencing. The client device includes the ability to capture, encode, and packetize local video and audio. The packetized video and audio are wirelessly transmitted to a network over a wireless communication link. The client device is also able to wirelessly receive, over the wireless communication link, a remote packetized stream including remote packetized video and audio streams. The client device depacketizes and decodes the remote video and audio streams. The video stream is then resynchronized to the audio stream and the synchronized streams are output. The video is output on a display and the audio is output using a speaker.

In another aspect, a server in a video conference system includes a session manager, a billing manager, and a heartbeat manager. The various managers combine to manage the video conference session and billing in a video conference system.

The features, objects, and advantages of the invention will become more apparent from the detailed description set forth below when taken in conjunction with the drawings in which like reference characters identify correspondingly throughout.

### BRIEF DESCRIPTION OF THE DRAWINGS

FIG. 1 is a functional block diagram of a communications system that is configured to provide video conferencing.

FIG. 2 is a functional block diagram of a communications system that is configured to provide video conferencing.

FIG. 3 is a diagram of the signal flow between a client and the communication network.

FIG. 4 is a functional block diagram of a client device interfaced to servers in the communication system.

FIG. 5 is a flowchart of a method of a client heartbeat thread.

FIG. 6A is a flowchart of a method of a client transmission thread.

FIG. 6B is a flowchart of a method of a client reception thread.

FIG. 7 is a flowchart of a method of a client request monitor thread.

FIG. 8 is a flowchart of a method of a client request generator thread.

FIGS. 9A-9B are flowcharts of a method of a conference manager initializing a client.

FIG. 10 is a flowchart of a method of a conference manager starting a video conference session.

FIG. 11 is a flowchart of a method of a conference manager aborting a video conference session.

FIG. 12A is a flowchart of a method of a conference manager processing a client heartbeat.

FIGS. 12B-12C are flowcharts of a method of a background process in a conference manager.

FIG. 13 is a flowchart of a method of a conference manager ending a video conference session.

FIG. 14 is a flowchart of a method of a conference manager determining video conference billing.

FIG. 15 is a functional block diagram of a communications system that is configured to provide video conferencing.

### DETAILED DESCRIPTION OF THE PREFERRED EMBODIMENT

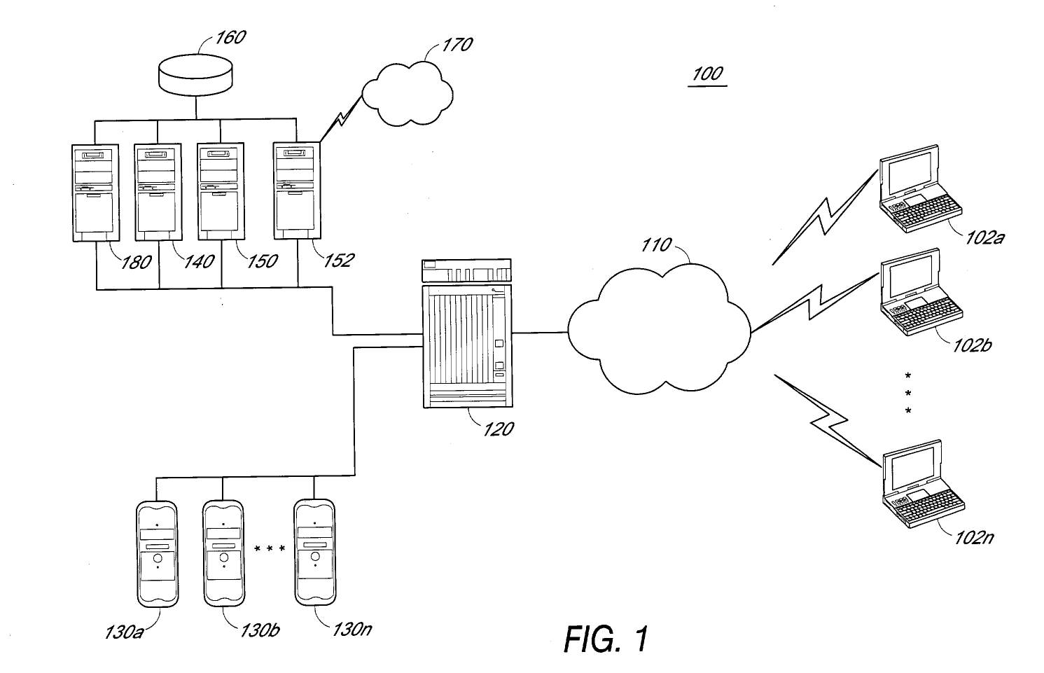

FIG. 1 is a functional block diagram of a video conference system 100. The video conference system 100 can provide access and support for multiple wireless client devices 102a-102n. The system 100 enables each of the client devices 102a-102n to initiate, or accept, video conference sessions with one or more of the other client devices 102a-102n. A particular client device, for example 102a, can initiate a video conference session with a single destination client device, for example 102b. Alternatively, a client device 102a can initiate a video conference session with multiple destination client devices 102b-102n. Although only three client devices 102a-102n are shown in FIG. 1, the video conference system 100 is expandable to support any number of client devices 102a-102n and can, for example, support thousands of client devices.

A client device, for example 102a, can access a wireless network 110 that enables communication with other client devices 102b-102n connected to the wireless network 110. The network 110 may include wireless links, wired links, and optically coupled links. An example of such a network is described in patent application Ser. No. 10/211,173, filed Jul. 31, 2002, entitled “WIRELESS METROPOLITAN AREA NETWORK SYSTEM AND METHOD” hereby incorporated herein by reference in its entirety.

Also connected to the wireless network 110 is a router 120 configured to route communications from source devices to destination devices. The router 120 is also configured to route communications from servers to client devices 102a-102n and route communications from client devices 102a-102n to servers.

The servers can include one or more content servers 130a-130n that are each connected to the router 120. The content servers 130a-130n are each configured to provide previously stored content to the client devices 102a-102n. For example, the content servers 130a-130n can be configured to store downloadable files, network messages, configuration information, email messages, voice mail messages, faxes, and the like. Client devices 102a-102n can access the content servers 130a-130n via the wireless network 110 in order to retrieve or store content.

Another server that can be connected to the router 120 is a billing system management application (BSMA) server 140. The BSMA server 140 can be included in the system 100 to manage, for example, customer accounts, video conference subscriptions, and media properties. The BSMA server 140 interfaces with the wireless network 110 and client devices 102a-102n to track transactions, such as video conference sessions, and relate the transactions to associated billing values. The BSMA server 140 can also be configured to provide an interface for system management functions. The BSMA server 140 can, for example, provide an interface to view alerts, and can be configured to handle and resolve some alerts relating to system errors and exceptions. These alerts can, for example, be related to database transaction failures, unauthorized access attempts, unauthorized service usage, and the like.

The BSMA server 140 can be configured as a stand-alone computer, such as an Intel MP server configured with dual Pentium 3 processors. The BSMA server 140 can also include internal memory, such as 32 GB of ECC SDRAM, RAID disk storage having a storage capacity of approximately 146 GB, and a network interface, such as a 100 base-T network interface. A BSMA server 140 configured as such can be expected to handle over 5000 customers, but can be scaled to support hundreds of thousands of customers utilizing multiple servers. Each customer is estimated to require 5 MB of memory to store the user account information. Additionally, a BSMA server 140 can support over 100,000 media properties of varying types and attributes, where a particular media property is estimated to use 100 kB. Furthermore, the BSMA server 140 can support the capability of over 100,000 video conference transactions per day for the supported users. The support capability is determined based on a maximum rate of 500 transactions per second. An average database access is estimated to take 100 milliseconds. The actual support capability varies based on the number of transactions per second handled by the BSMA server 140.

One or more servers can also be configured as Customer Service Application (CSA) servers 150, 152. The CSA servers 150, 152 can be configured to be in communication with a database 160. The database 160 can be configured to store user account information.

A CSA server, for example 150, can be configured to interface with a customer accessible portal, such as a web site on the Internet. The CSA server 150 allows the customer to update personal profile information, view service subscriptions, view recent activities and view billing statements. Additionally, the CSA server 150 can allow the user to define preferred payment methods, including such factors as billing date, credit card numbers, and checking account numbers for automated bill payment. The CSA server 150 can also provide user access to customer support services such as reporting lost or stolen handheld devices, disputing charges, reviewing FAQs, and accessing system administrator contact information. The web-based CSA server 150 can be configured to authenticate customers using a user password over a one-way server-authenticated Secure Socket Layer (SSL) connection.

Another CSA server, for example 152, can be configured to provide user access through an alternative portal, such as through a telephone system. The CSA server 152 can be connected to a telephone interface 170 to allow many of the same services provided by the Internet accessible CSA server 150. For example, the CSA server 152 can be configured to allow a user to update user profile information, review account information, review usage, and review system activity. The CSA server 152 performs user authentication and can retrieve and update customer data. The retrieved information can be presented to the user as a voice message. Alternatively, requested information can be sent to the user through another means, such as by mail, fax or via email as a message or attachment.

The telephone system-based CSA server 152 can be configured to operate using a voice-based system commands. The voice-based system can be configured to implement a voice recognition system. The voice recognition system can utilize voice print technology for verification, and can be speaker independent with no voice training. The voice recognition system can perform voice to text conversion to allow a user to leave a text message, or to allow data entry via voice commands. Alternatively, the voice recognition system can be speaker dependent and use some level of user training. Alternatively, or in addition to voice recognition, the CSA server 152 can be configured to respond to DTMF touch-tone data entry.

The CSA servers 150, 152, can each be configured similarly to the BSMA server 140. Each CSA server 150, 152, can be configured as a stand-alone computer, such as an Intel MP server configured with dual Pentium 3 processors. The CSA servers 150, 152, can also include internal memory, such as 32 GB of ECC SDRAM, RAID disk storage having a storage capacity of approximately 146 GB, and a network interface, such as a 10 base-T network interface.

The web-based CSA server 150 configured as such can provide support for up to 1600 customers simultaneously, and can be scaled to support more customers simultaneously. A voice-based CSA server 152 configured as such can support 23 simultaneous support phone calls and is scaleable to 100 or more simultaneous telephone calls.

A video server 180 can also be connected to the router 120 and have access to the database 160. The video server 180 is optional and is used for video conference configurations that use a video server to multicast video and audio from a source client device, e.g. 102a, to multiple destination client devices, e.g. 102b and 102n. The video server can receive the video stream, audio stream, and addresses of the destination client devices and multicast the video stream and audio stream to the destination client devices. If multicast capability from a video server 180 is not used or desired, the video server 180 can be omitted from the system.

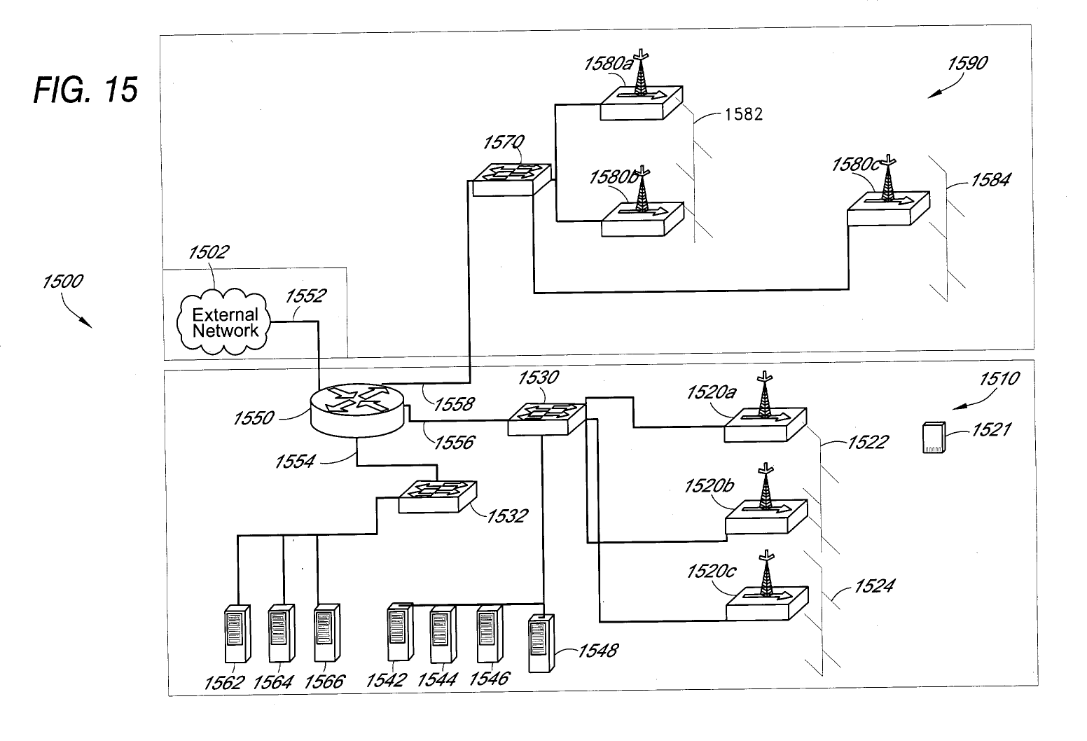

FIG. 15 is a functional block diagram of an embodiment of a metropolitan area network (MAN) 1500 configured to enable communication that can support video conferencing. The MAN 1500 of FIG. 15 is an example the network 110, router 120, and servers 130-130n, 140, 150, 152 shown in FIG. 1. The client device 1521 in FIG. 15 can be one of the client devices 102a-102n from FIG. 1. FIG. 15 provides a more detailed diagram of the interconnections and interfaces in the network. Although only one MAN 1500 is shown in FIG. 15, multiple MANs can communicate with one another over a high speed communication link, such as a fiber optic link using packet-over-SONET. Then, a client device 1521 can, engage in a video conference session with a client device on another MAN (not shown).

The MAN 1500 is configured to provide broadband communications, and can be configured to provide communication link between client devices capable of carrying 6 Mbps. The MAN 1500 includes a first sub-network 1510 and a second sub-network 1590 connected to a single router 1550. The sub-networks, 1510 and 1590, are connected to the router 1550 in a star configuration such that only a single router 1550 is used. A star configuration, or star topology as it may alternatively be called, uses a set of point to point links that radiate from a central location. The router 1550 is the central location in the MAN 1500 star configuration. Although only two sub-networks, 1510 and 1590, are shown in FIG. 15, any number of sub-networks can be connected to the router 1550.

The following network 1500 is described using references to OSI layers. However, communication over the network 1500 is not limited to communication protocols aligning with OSI layers. More generally, the systems and methods apply to networks implementing layered communication protocols.

The MAN 1500 shown in FIG. 15 includes a router 1550 having a plurality of ports. The router 1550 performs routing and packet forwarding functions using the network layer, or layer three, information embedded in data packets transmitted to a port on the router 1550. The router 1550 stores routing tables that allow it to determine to which port data packets are to be routed. For example, the router 1550 can be a CISCO 12000 series router, from Cisco Systems, Inc.

Alternatively, a controller, such as a Media Access Control (MAC) layer controller, can be connected to the router 1550. The controller can store the MAC layer addresses of various devices within the network and associate ports on the router 1550 with addresses. The router 1550 operates in conjunction with the controller to determine the correct port to which packets are to be routed.

For example, a client device 1521 can be associated with a first access point 1520a. The client device 1521 can request content from an IP address corresponding to a server, e.g. 1562. The MAC controller can store information that indicates the communication path from the client device 1521 to the router 1550. The client device 1521 communicates to the first access point 1520a. The first access point 1520a communicates with the second switch 1530 and the second switch communicates with the router 1550. Additionally, the MAC controller can store information that indicates the communication path from the router 1550 to the video server 1562. The router 1550 communicates with a first switch 1532, which communicates with the video server 1562.

Each port on the router 1550 is coupled to a device by a network branch. Three of the ports are coupled by network branches, 1554, 1556, and 1558 to switches 1532, 1530, and 1570 respectively. A fourth port is connected to an external network 1502. The external network 1502 can be a meshed network having a plurality of routers, and can be another sub-network, or the external network 1502 can be a Wide Area Network (WAN), such as the Internet. The MAN 1500 can be configured such that the network branch 1552 coupling the port on the router 1550 to the external network is intentionally bandwidth limited. The network branch 1552 operates as a bottleneck for data passing from and to the network 1500. For example, the network branch 1552 connecting the router 1550 to the external network 1502 can be a 10Base TX or 100Base TX communications link, or some other link having only limited data rate capabilities. A switch, such as the first switch 1532, is a multi-port device that selectively forwards packets from one of its ports to another. The switch's forwarding decision is based on layer two information. The switch 1532 does not modify a received packet. For example, the switch 1532 can be a CISCO 3500 series switch from Cisco Systems, Inc., such as a 3508 Ethernet switch.

One or more devices are connected to one or more of the other ports on the first switch 1532. Three servers, 1562, 1564, and 1566, are shown coupled to a port on the first switch 1532 that is different from the switch port that is connected to the router 1550. For example, each of the servers 1562, 1564, and 1566 can store video content or some other type of data or information. The server software can support one or more forms of video compression, such as Motion Picture Experts Group (MPEG) video compression, such as MPEG2 or MPEG4. A high quality video stream encoded using MPEG2 uses approximately six Mbits per second of data bandwidth. In one embodiment, the connection from the server 1566 to the first switch 1532 is a 100Base FX fiber connection capable of supporting 1000 Mbit/s. The server is then limited to providing 166 video streams encoded using MPEG2 video compression. For example, each of the servers 1562, 1564, and 1566 can be an Apple Xserve™ computer running streaming server software such as Quicktime™. Each seer can then be able to support sixty video streams.

The second switch 1530 has a first port connected to a port on the router 1550. A second port on the second switch 1530 is connected to a plurality of servers. The plurality of servers can include an IP/TV control server 1542, an IP/TV content server 1544, an IP/TV broadcast server 1546, and a Dynamic Host Configuration Protocol (DHCP)/Domain Name System (DNS) server 1548. Alternatively, the servers 1542, 1544, 1546, and 1548 can include the BSMA server 140 and the CSA servers 150, 152 of FIG. 1. A third port on the second switch 1530 is connected to a number of access points 1520a-1520c. A link is used to connect each access point 1520a-1520c to the port on the second switch 1530.

The access points 1520a-1520c provide wireless interfaces from the network 1500 to client devices, for example a client device 1521 near the first access point 1520a. The client devices do not form a part of the network 1500, but are able to connect to and communicate over the network 1500 using, for example, a wireless link to an access point 1520a-1520c.

Servers that perform administration, such as the IP/TV control server 1542, or the DHCP/DNS server 1548 typically do not require high data rate connections to the network. Thus, the connection from the servers 1542 and 1548 can be lower rate connections such as a 100Base TX link.

The IP/TV servers 1542, 1544, and 1546 can be configured to broadcast multicast video streams to client devices connected to the network 1500. The third switch 1570 operates in a second sub-network 1590. A first port on the third switch 1570 is connected to a port on the router 1550. A second port on the third switch 1570 is connected to three access points 1580a-1580c within the second sub-network 1590. A link connects each of the access points 1580a-1580c to the port on the third switch 1570. The three access points 1580a-1580c connected to the third switch 1570 provide wireless access to the second sub-network 1590 of the network 1500.

The MAN 1500 can be configured to support any type of data protocol. For example, the MAN 1500 can be an Ethernet network operating in accordance with IEEE 802.3. In alternative embodiments, the MAN 1500 can communicate using Asynchronous Transfer Mode (ATM), or some other communications protocol.

Any of the network branches, 1552, 1554, 1556, and 1558 can be implemented using wireline links or wireless links having sufficient bandwidth. The network branches 1554, 1556, and 1558 connecting ports on the router 1550 to switches 1532, 1530, and 1570 respectively, can be 100Base FX multimode fiber links. The network branches 1554, 1556, and 1558 can, for example, be free space optical links. Similarly, any of the links from the switches 1530, 1532, and 1570 can be implemented using wireline links or wireless links of sufficient bandwidth. Examples of links include, but are not limited to, wired links, radio frequency links, and optical links, including fiber and free space optical links.

The first sub-network 1510 shows three of the connection points configured as access points 1520a-1520c adapted to operate as wireless connection points to the network 1500. For example, the access points, 1520a-1520c, can operate in accordance with IEEE 802.11. Furthermore, the access points 1520a-1520c can be configured to operate according to IEEE 802.11a or IEEE 802.11b, or some other wireless interface standard, and within each particular standard, the access points 1520a-1520c can be configured to operate in any of the frequency bands defined within the specifications. For example, an access point 1520a-1520c can be configured to operate in one or more of the frequency bands specified for the three regions defined in IEEE 802.11. Alternatively, proprietary protocols can be used and the wireless links can operate in one or more frequency bands in combination with, or exclusive of, wireless links that operate using one or more optical wavelengths.

The MAN 1500 can be configured to prioritize video conference traffic. For example the MAN 1500 can prioritize video conference packets over video on demand, or some other content that is relatively time insensitive. The video conference application can be prioritized or the type of protocol used in video conferencing can be given priority in the MAN 1500. For example, the MAN 1500 can prioritize Real Time Protocol (RTP), which may be associated with video conferencing. The router 1550, switches e.g. 1532, and access points e.g. 1520, can each be configured to prioritize video conference protocols. For example, the router 1550 can prioritize RTP data over other types of data. Additionally, within a video conference session the audio stream can be prioritized over the video stream by prioritizing the audio packets in the router 1550, switches, e.g. 1532, or access points, e.g. 1520. Alternatively, communication of video conference data can be assigned a higher priority over other types of data, for example through the transport protocol.

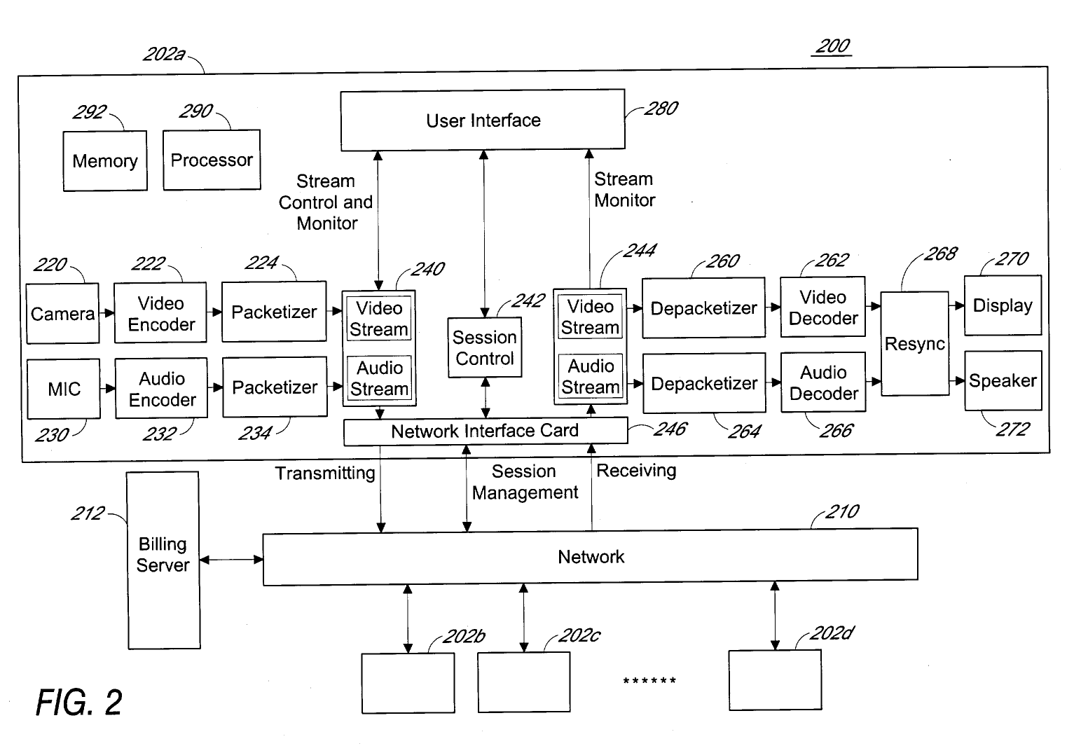

FIG. 2 is a functional block diagram of a portion of a video conference system 200, for example, the video conference system of FIG. 1. The video conference system 200 of FIG. 2 includes a detailed functional block diagram of selected portions of one of the client devices 202a. As in the video conference system 100 of FIG. 1, the video conference system 200 of FIG. 2 includes multiple client devices 202a-202d interfacing with a network 210. Each of the client devices 202a-202d can be, for example, one of the client devices shown in FIG. 1 or FIG. 15. The network 210 of FIG. 2 can be the network 110 of FIG. 1.

The communication links from the client devices 202a-202d to other devices on the network 210 can include wireless links, as well as wired links, or optical links. For example, the communication link from the first client device 202a to the network 210 can be a wireless link operating in accordance with IEEE 802.11a.

A billing server 212 is also connected to the network 210 and is in communication with the client devices 202a-202d. The billing server 212 can be a portion of the BSMA server 140 of FIG. 1, and is shown as a stand-alone computer that forms part of the BSMA server. The billing server 212 is in charge of tracking the billing during a video conference session between two or more of the client devices, for example 202a and 202b.

A functional block diagram of the functional elements used for video conferencing by the first client device 202a is provided. Each of the other client devices 202b-202d can be configured similarly to the first client device 202a. The first client device 202a can be implemented using various hardware platforms. For example, the first client device 202a, or any of the other client devices 202b-202d, can be a personal computer, a desktop computer, notebook computer, a tablet computer, a pocket computer, a handheld computer, and the like. The first client device 202a can be a multi-purpose machine, or a dedicated video conferencing device. The first client device 202a can use various operating systems including, but not limited to, Windows, Linux, Unix, other real time operating systems, and the like.

The first client device 202a can video conference with a single remote device or with multiple remote devices. The first client device 202a can engage in a video conference with multiple remote devices concurrently by independently enabling a session with each remote device. Thus, the first client device 202a can operate many independent video conference sessions. A first client device 202a engaged in video conferences with two remote devices can independently initialize, activate, and terminate each session. The transmit signals from the first client device 202a can be unicast directly to each of the remote devices. Alternatively, the client device can transmit signals to a video server that, in turn, multicasts the signals to the multiple remote devices engaged in the video conference.

One feature of independent sessions is the ability for only some of the parties in a multiple client video session to be in communication with one another. This scenario is easily illustrated in a three client session, although the same features can be extended to any session having more than two parties. A first client device 202a can engage in an active video conference session with a second client device, for example 202b. The first client device 202a can then initiate a video conference session with a third client device, for example 202c. However, the second client device 202b and the third client device 202c are not in communication. If the second client device 202b desires to video conference with the third client device 202c, an independent video conference needs to be set up between those devices. Typically, one of the second or third device, 202b or 202c, would initiate the video conference with the other device. In one embodiment, for billing purposes, the second video conference between device 202b and device 220c is billed to the device initiating the video conference, for example the second client device 202b.

Multiple video conference sessions can be displayed by the client device as multiple windows, with one window displaying the received video for each active session. The different windows can be displayed in tile format where each of the windows is simultaneously viewable, in overlapping windows, or as a combination of tiled and overlapping windows. If overlapping windows are used, the user, through the user interface 280 can configure the client device 202a to automatically switch the active window. That is, the client device 202a can automatically display one of the windows on top of the others. One manner in which this can be accomplished is through the use of silence detection in the audio decoder 266. The window having an audio signal can be displayed on top of the other windows. Thus, during a multiple window video conference session in which each client takes turns speaking, the client device 202a displays, as the active window, the window corresponding to the client that is speaking. During a multiple window session, the client device 202a can change many times, automatically, the window that is displayed as the active window.

Alternatively, the user can prioritize the multiple active video conference sessions. Thus, the user can choose to prioritize a first video conference session over a second video conference session. In this case, the client device implements automatic, intelligent switching of windows to display the windows in the priority order so that the higher priority window is active over the lower priority window regardless of the state of the audio decoder silence detection.

The first client device 202a can also be configured to use a second client device, for example 202b, as a remote monitor. The second client device 202b can be configured to automatically answer call requests. The second client device 202b can be configured to automatically answer a call request having particular attributes, such as, a source IP address corresponding to the IP address of the first client device 202a, a source MAC address of the first client device 202a, or a user ID associated with the first client device 202a. Thus, the second client device 202b can be configured as a remote monitor controlled by the first client device 202a. The camera and microphone from the second client device 202b can be configured to monitor an area of interest. In a remote monitoring configuration, the remote second client device 202b transmits a video and audio stream to the first client device 202a, but the first client device 202a typically does not transmit video and audio to the remote monitor. Thus, the second client device 202b acts as a one way broadcast source. Alternatively, the first client device 202a can initiate transmission of video and audio signals to the remote monitor and establish two-way video conference with the remote monitor.

The first client device 202a performs two major functions during a video conference session. The first major function is transmission. Transmission refers to the process of source video capture, encoding, packetizing, and transmitting packets to other devices connected to the network 210. The other major function is reception. Reception refers to the process of receiving packets, depacketizing, decoding, and rendering the video and audio streams from other devices over the network 210. Additionally, the first client device 202a performs the overhead functions associated with transmission and reception. These overhead functions can be summarized as video loopback rendering, monitor and control functions.

The first client device 202a has three primary communication streams that can run simultaneously. Each of the streams interface the network 210 to the client device 202a using a Network Interface Card (NIC) 246. The NIC 246 can be configured to format the data according to a communication protocol used by the network 210. For example, the NIC 246 can be a wireless interface that wirelessly communicates with the network 210 using IEEE 802.11a format and communication protocols.

A first data stream is the transmitting data stream which includes the video and audio data generated local to the first client device 202a and transmitted to the network 210 to be distributed to one or more devices. A second data stream is the receiving data stream which includes the video and audio data that is generated remotely to the first client device 202a. The remotely generated data can, for example, be generated and transmitted by another client device 202b engaged in a video conference session with the first client device 202a. The transmitting data stream and the receiving data stream are typically unidirectional data streams. The transmitting data stream originates at the client device 202a and is provided to the network 210. Conversely, the receiving data stream is generated remotely by the second client device 202b and thus flows from the network 210 to the first client device 202a.

A third data stream is a bi-directional session management stream. The session management stream includes the control data passed between the first client device 202a and other devices connected to the network 210. The control data can include, for example, authentication data used by the client device 202a to establish that it is a valid user of the network 210. The control data can also include session information from the billing server 212, or call requests that are transmitted to a destination device connected to the network with which the first client device 202a wishes to establish a video conference session. Additionally, the control data can include a heart beat message that is periodically transmitted by the first client device 202a to the billing server 212 during an active video conference session to indicate an active session and to assist in the calculation of a bill for the video conference session. Of course, the list of control data that can be passed to and from the first client device 202a is not exhaustive, and other control data can be passed to and from the first client device 202a.

The first client device 202a typically captures both audio and video to be transmitted. Although all the devices engaged in a video conference are not required to capture both audio and video, communication between users at remote locations can more closely simulate an in-person meeting when both video and audio are captured and transmitted by all users in the video conference session.

The first client device 202a includes a camera 220 to capture the local video image. The camera 220 can be integrated into the first client device 202a or, alternatively, the camera 220 can be external to the first client device 202a and interface with the first client device 202a via a communication link or external connection. Regardless of whether the camera 220 is integrated into the first client device 202a, the communication link between the camera 220 and the video encoder 222 needs to have sufficient bandwidth to communicate the video stream.

Presently, portable cameras 220 are available that provides captured video in a digital data stream. For example, digital cameras 220 can capture video at a resolution of 640×480 at 30 frames per second (fps). For example, the camera 220 can be a digital camera which provides a minimum of 310K of pixels and is integrated into a front panel of the client device 202a. The digital data generated by the camera 220 can interface with the first client device 202a using a Universal Serial Bus (USB) or IEEE-1394 communication link. Other communication protocols between the camera 220 and other elements of the first client device 202a can also be used. Additionally, the camera 220 and the first client device 202a can support other video resolutions.

Alternatively, or in addition to video captured from a camera 220, the client device can accept video from any video source, such as pre-recorded video, or video from a video distribution system. The video can be multiplexed with the live video captured by the camera 220, or can be provided in lieu of the captured video.

Other signal inputs can be provided on the client device 202a. For example, the client device 202a can receive text that accompanies the video and multiplex the text with video to provide a closed captioned video signal. Alternatively, the client device 202a can accept an audio signal and include a voice detection module, or speech recognition module, and speech to text conversion module to convert the audio to text. The client device 202a can also store processor readable instructions in the memory that instruct the processor to perform voice detection, speech recognition, and speech to text conversion. The converted audio can then be multiplexed with the video to provide closed captioned video for transmission.

The captured video is sent from the camera 220 to the video encoder 222. The video encoder 222 is configured to encode the captured video. Encoding the video stream can allow the stream to be compressed, thereby occupying less signal bandwidth. The video encoder 222 is configured to selectively encode the video stream using one encoding algorithm from multiple available encoding algorithms. The video encoder 222 can, for example, be configured to perform any one of the video encoding algorithms defined by the International Telecommunications Union (ITU) and International Standards Organization (ISO), such as H.263+, MPEG-2, MPEG-4, Motion-JPEG, and Motion-JPEG2000. The video encoder 222 can be configured to perform a subset of the previously mentioned video encoding algorithms. Alternatively, the video encoder 222 can be configured to perform other video encoding algorithms, including proprietary encoding algorithms. The alternative video encoding algorithms can be provided instead of, or in addition to, those algorithms previously listed. The video encoder 222 can be implemented as hardware or can be implemented in software as processor readable instructions stored in a memory 292 that interfaces with a processor 290. Alternatively, the video encoder 222 can be implemented in a hardware device that implements other functional blocks of the client device 202a. For example, a hardware codec can incorporate both the video encoder 222 and the video decoder 262.

The video encoder 222 can support low resolution video encoding of images having a definition of 160×120 and 320×240. If the encoder 222 is configured to perform one of the two intra-frame encoding, Motion-JPEG and Motion-JPEG2000, the client device 202a can support up to 30 frames per second (fps) video compression with an image resolution up to 640×480. If the encoder 222 is configured to perform one of the two inter-frame video encoding, MPEG-2 and MPEG-4, the client device 202a can support encoding of 640×480 and 720×480 at a rate of up to 30 fps. MPEG-2 also supports definitions up to 1920×1080. Of course, the signal bandwidth increases as image resolution or frame update rate increases. Table 1 provides a list of popular frame definitions and a list of video encoders supporting that definition. The video encoder 222 can be configured to support some, or all of the definitions shown in Table 1. Table 2 provides a range of the bit rate for video signals generated by the video encoder 222 performing the various encoding algorithms.

TABLE 1

| | MPEG-2 | MPEG-4 | M-JPEG | M-JPEG2K | H.263+ |
|---|---|---|---|---|---|
| 160 × 120 | X | X | X | X | X |
| 320 × 240 | X | X | X | X | X |
| 640 × 480 | X | X | X | X | |
| 720 × 480 | X | X | X | X | |

TABLE 2

| | MPEG-2 | MPEG-4 | M-JPEG | M-JPEG2K | H.263+ |
|---|---|---|---|---|---|
| Bit Rate | 640-6000 | 64-1200 | 128-6000 | 128-4000 | 64-1000 |
| (Kbps) | | | | | |

A user, via the user interface 280, can independently select a resolution and type of encoder used in a video conference session. The user can input a resolution or encoder selection into the user interface 280. The user interface 280 communicates the selections to the session control module 242 that controls the video encoder 222 to provide the selected resolution and encoding algorithm. Additionally, the resolution and encoding type selected in a transmit signal is selected independently of the resolution and encoding type received over the network 210 from a remote user. Furthermore, the user, via the user interface 280, can command the client device 202a to change the resolution or encoding type during an active video conference session. The session control module 242 can control the configuration of the video encoder 222 and modify its configuration during an active video conference session. This ability to change the resolution and encoding type on-the-fly during an active session can be advantageous in a situation where the quality of a communication link changes. For example, when the communication link degrades, the quality of a video conference session can degrade based in part on the selected video resolution. The session control module 242 can determine that the many of the transmitted packets are not being delivered and can choose to decrease the video resolution or change the video encoding to a more efficient type in order to decrease the bandwidth required to transmit the video signal. A decreased bandwidth can relate to an increased probability of successful data delivery.

The user can determine the quality of the transmitted video signals, in part, on a feedback signal that can be transmitted by a destination device. The feedback signal is received as a feedback message received by the session control module 242. The destination device can, for example, transmit a feedback signal that indicates a received signal quality, such as a rate of dropped packets. Alternatively, the session manager can provide a feedback signal to the client device 202a. The session control module 242 can then update the configuration of the client device 202a, such as by reducing the video resolution, to improve the signal quality received by the destination device. The client device 202a can also determine a quality of the received video, for example by measuring a rate of dropped video packets. The rate of dropped packets can then be included in a feedback message generated by the session control module and transmitted to the client device sending the video.

A video packetizer 224 is connected to the output of the video encoder 222. After the video stream is encoded in the video encoder 222, the video stream is provided to the video packetizer 224 to be packaged as packet data. A video packetizer 224 is advantageous where the video stream is to be transmitted as data packets in a packet-switched network.

Real Time Transport Protocol (RTP) is one standard that has been adopted for real-time video and audio data transmitted over multicast or unicast networks. The video packetizer 224 implementing RTP adds overhead bits to the previously encoded video stream. Thus, in an MPEG-2 encoded video stream, the packetized data would include an RTP header followed by an MPEG-2 header and further followed by the associated MPEG-2 data payload. The information in the received RTP stream can be used to assist in determining a rate of dropped packets. The rate of dropped packets can then be included in a a feedback message to a source device.

Additionally, the first client device 202a can be configured to transmit RTP over a transmit protocol such as Transmission Control Protocol (TCP), or User Datagram Protocol (UDP). The session control module 242 can control the packetizers 224 and 234 and transmit stream controller 240 to implement a specific transport protocol. In one embodiment, the client device 202a uses RTP over TCP to provide a reliable data stream. Alternatively, the client device 202a can be configured to provide RTP over UDP if a connectionless, best effort, transport protocol is desirable. Because most video conference sessions can be sensitive to time delays and there may not be sufficient time to retransmit dropped data packets, a connectionless, best effort, attempt to deliver packets to the destination may be preferred. The UDP transport protocol uses less overhead than does a TCP transport protocol, which may also make UDP a preferred transport protocol. The first client device 202a can also be configured to selectively provide both transport protocols.

Similar to the just described video capture portion of the system, audio is captured using a microphone 230 that can be integrated within the first client device 202a or external to the first client device 202a and interface via a communication link and external connection. Alternatively, more than one microphone 230 can be used to capture sound. For example, stereo microphones having a frequency of 20 Hz to 15,000 Hz can be integrated into opposite ends of the front face of a client device 202a to capture stereo sound.

The output of the microphone 230 is connected to an audio encoder 232. The audio encoder processes a digitized audio stream in part, by compressing, companding, filtering, amplifying, or otherwise processing the data. The audio encoder 232 can implement any of a variety of algorithms. For example, the audio encoder 232 can implement Pulse Code Modulation mu-Law (PCMU) encoding, which encodes audio as eight bits per sample following logarithmic scaling. The logarithmic scaling is performed according to a mu-law companding curve. PCMU encoding is often used in packet based networks, such as Internet audio.

Alternatively, or in addition to PCMU encoding, the audio encoder can be configured to selectively provide Adaptive Differential Pulse Code Modulation (ADPCM), Motion Picture Experts Group audio layer 3 (MP3), ITU A-law or ITU I-law encoding. As was the case for the video encoding, the client device 202a can be configured to allow the user to select one of the audio encoders, and can be configured to allow changing the audio encoder on-the-fly.

The output of the audio encoder 232 is connected to an audio packetizer 234 where the encoded audio stream is packetized for transmission over a packet-switched network 210. After the audio stream is processed by the packetizer 234, the audio stream is provided to a transmit stream controller 240. The packetized video stream is also provided to the transmit stream controller 240.

The transmit stream controller 240 receives control signals provided from a user interface 280. When the first client device 202a is engaged in an active video conference session, the transmit stream controller transmits the video and audio streams, via the NIC 246, over the network 210 to one or more destination devices. Thus, when the NIC 246 is in wireless communication with the network, the transmit stream controller 240 can wirelessly transmit the packetized streams to the network using the NIC 246.

Additionally, the transmit stream controller 240 can route the packetized video and audio to the receive stream controller 244 for local processing and presentation. Routing the packetized video and audio from the transmit stream controller 240 to the receive stream controller 244 is typically referred to as loopback. During loopback, the transmit signals provided to the NIC 246 can be looped back within the NIC 246 as receive signals that are then coupled to the receive stream controller 244. One advantage of providing a loopback signal is the ability to verify all operations within the client device 202a are functioning. Alternatively, in order to reduce processing overhead, the locally generated video can be coupled to a display device without the encoding, packetizing, depacketizing, and decoding operations performed in the loopback mode. However, the encoding and packetizing is still performed for signals that are transmitted to the network.210.

The transmit stream controller 240 can be configured to transmit the packetized streams to the destination devices connected to the network. The transmit stream controller 240 can be configured to wirelessly transmit the packetized streams via the NIC 246 when the communication link from the first client device 202a to the network 210 includes a wireless communication link. The transmit stream controller 240 can be configured to transmit the packetized streams at a rate sufficient to enable high quality video conferences. For example, the transmit stream controller 240 can be configured to transmit the packetized streams at a rate that is approximately equal to, or greater than, about 1 Mbps, 2 Mbps, 3 Mbps, 4 Mbps, 5 Mbps, or 6 Mbps. The NIC 246 receives the packetized transmit streams and formats them for transmission across the wireless link to the network 210. The NIC 246 can be configured, for example, to implement IEEE 802.11a wireless communication to the network 210 at a rate of up to 6 Mbps.

The NIC 246 is also configured to wirelessly receive packetized video and audio streams from the network and provide the received packetized streams to the receive stream controller 244. The receive stream controller 244 performs a function that is complementary to the function performed by the transmit stream controller 240. The receive stream controller 244 receives remote packetized video and audio streams from remote devices over the network 210 as well as local packetized video and audio streams from the transmit stream controller 240. The receive stream controller 244 provides the received video streams to a video depacketizer 260. Similarly, the receive stream controller 244 provides the received audio streams to an audio depacketizer 264. The received remote packetized video and audio streams can be wirelessly received over a wireless communication link to the network 210. The received video and audio streams can be received at a rate that is equal to, or greater than, about 1 Mbps, 2 Mbps, 3 Mbps, 4 Mbps, 5 Mbps, or 6 Mbps.

At these data rates, the client device 202a can support video conference sessions having high definition video. These video conference sessions can use video resolutions of, for example, 640×480, 720×480, 1280×720, and 1920×1088 at a frame rate of up to 30 frames per second. Other video resolutions are possible and the frame rate is not limited to 30 frames per second but can be nearly any frame rate supported by the devices and the communication bandwidth. For example the frame rate can be equal to or greater than 24, 25, 30, 40, 50, or 60 frames per second. Not all system configurations may be able to support all frame rates. The various frame rates can be limited to use when the hardware, software, and communication bandwidth support these frame rates.

The video depacketizer 244 removes the packet overhead from the received packetized video stream to recover an encoded video stream. The output of the video depacketizer 260 is connected to a video decoder 262. The video decoder 262 recovers the video stream from the encoded video stream provided by the video depacketizer 260. The video decoder 262 decodes the video stream using the complement of the process used for encoding of the stream. The video decoder 262 can decode multiple video formats. The received video streams can, but are not required to be, encoded using the same encoding algorithm used in generating the transmit video stream. Thus, the multiple video streams corresponding to the users engaged in an active video conference can use one or more video encoding and decoding algorithms.

Similarly, the audio depacketizer removes the packet overhead from the received audio to recover an encoded audio stream. The output of the audio depacketizer 264 is connected to the input of an audio decoder 266. The audio decoder 266 recovers the audio stream from the encoded audio stream provided by the audio depacketizer 264. As was the case for the received video streams, the received audio streams can all use the same encoding or can use different encoding. The audio decoder 266 can decode multiple audio formats. The audio decoder 266 decodes the audio stream using the complement of the process used for encoding of the stream.

The output of the video decoder 262 is connected to a resynchronizer 268. The output of the audio decoder 266 is also connected to the resynchronizer 268. The resynchronizer 268 synchronizes the received video stream to the corresponding received audio stream. The output of the resynchronizer 268 is connected to user presentation devices.

The synchronized video output is provided to a display 270 for presentation to the user. The display 270 is shown as integrated with the first client device 202a. However, the display 270 can be external to the first client device 202a and can interface with the first client device 202a via an external connection. The display 270 can also be a single display or multiple displays, with each display presenting a different video stream.

The synchronized audio output is similarly provided to a speaker 272 for presentation to the user. The speaker 272 can be implemented as a single speaker or as multiple speakers. Multiple speakers can be advantageous when the audio is captured and recovered in stereo. The speaker 272, or multiple speakers, can be integrated with the first client device 202a or can be external to the first client device 202a.

A user interface 280 provides an input device for a user to input data and commands. The user interface 280 can accept the user commands to, for example, initialize, start, abort, or terminate a video session. The commands entered by the user at the user interface 280 are communicated to the session control module 242 to be further processed. The user interface 280 can include a keyboard, keypad, touch screen, buttons, knobs, dials, switches, slides, voice recognition, image recognition, and the like, or any other means for inputting user instructions.

Additionally, the first client device 202a includes a session control module 242 that communicates with servers, such as the billing server 212, and other client devices, such as 202b-202d, to set up, manage, and terminate video conference sessions. The session control module 242 also oversees and manages the video conference session at the client device.

The session control module 242 can accept the user inputs to initiate a video conference session with a remote device. The session control module can then be configured to communicate the request to the billing server 212, and receive the response. The session control module 242 can also manage the various functional blocks within the client device 202a during a video conference session. For example, the session control module 242 can control the camera 220 and microphone 230 to begin capturing video and audio after the start of a video conference session. Additionally, the session control module 242 can control the encoders 222 and 232 to select the type of encoding and to initiate encoding of the captured streams. The session control module 242 can also control the corresponding functional blocks in the receiving rendering portion of the client device 202a. The session control module 242 can control the depacketizers 260, 264, decoders 262, 266 and resynchronizer 268 to begin operation once a video conference becomes active.

The session control module 242 can periodically send a heartbeat or other control message to the billing server 212 to indicate a video conference is active and to help the billing server 212 track billing. The session control module 242 can also send a termination message to the billing server and can receive a termination message originating from the billing server.

One or more of the functional blocks of the first client device 202a can be implemented as hardware, as software stored in memory 292 and running on a processor 290, or as a combination of hardware and software. The memory 292 can be a combination of volatile memory and non-volatile memory. For example, the memory 292 can be a combination of RAM, ROM, and magnetic memory. In another example, the memory 292 can include flash memory, NV-RAM, and removable drives. The memory 292 can, for example, be 500 MB, 1 GB, 20 GB, or more, or any other quantity of memory.

The memory 292 can also be configured to store messages associated with rejected call requests. For example, a video message up to a maximum predetermined length can be received and stored by the client device even though the call is not accepted. Additionally, the client device can be configured to record active video conference sessions. For example, the client device 202a can be configured to store up to one hour of a video conference session if 1 GB of memory is available. The client device 202a is typically configured to store the session as compressed data in order to reduce the memory requirements. The actual maximum recording capability of the client device 202a is dependent on the video and audio encoding, the video resolution, and the amount of memory 292 in the client device 202a.

Additionally, although the functional blocks are shown as being separate, one or more functional blocks can be implemented in the same hardware, software, or combination of hardware and software. For example, the video encoder 222 and the video decoder 262 can be incorporated into a single hardware video codec.

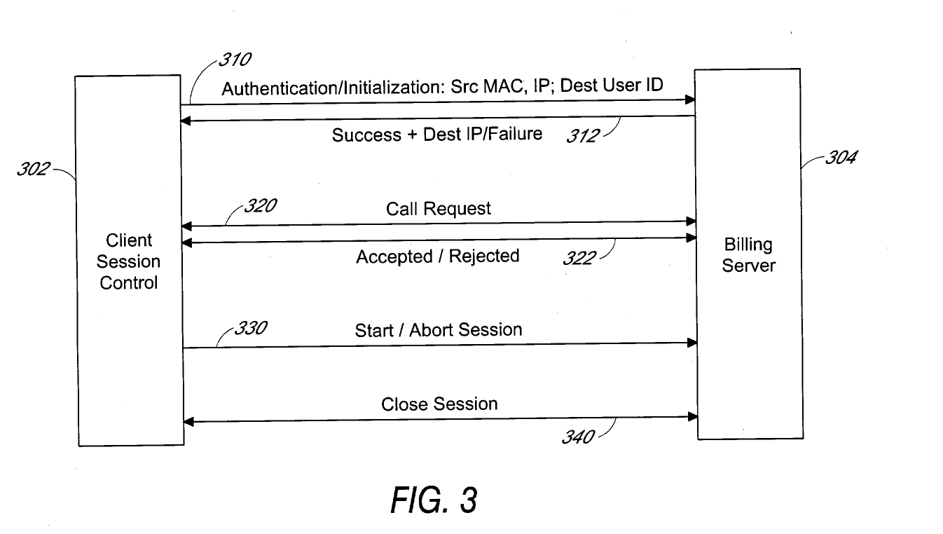

FIG. 3 is a block diagram of the signal flow between a client device, such as the client device 202a of FIG. 2, and a server connected to the communication network. The signal flow block diagram of FIG. 3 illustrates the process that a client device and a billing server use in setting up and terminating a video conference session.

The client session control module 302 can be the session control module 242 described in FIG. 2. Additionally, the billing server 304 can be the billing server 212 described in FIG. 2.

The client session control module 302 initially authenticates its client device with the video conference system by transmitting an authentication message 310 to the billing server 304. The message initiated by the session control module 302 can be processed using a NIC, such as the NIC described in FIG. 2. The NIC can wirelessly transmit the session control messages to the network where other communication links in the network communicate the message to the billing server 304. The authentication/initialization message 310 can, for example, include the Media Access Control (MAC) address and IP address of the source client device, and the destination client's user ID. In some networks, the IP address of the client device is static and thus does not change. Therefore, a static IP address can be used to identify a particular client device. Additionally, even if a dynamic IP address is used by the client device, the user ID can be a unique value identifying a particular client device. Other means for identification can be transmitted in an authentication message including, but not limited to user codes, serial numbers, device names, and the like. The billing server 304 receives the authentication message and sends an authentication response message 312 to indicate whether the authentication process succeeded or failed. The client session control module 302 can retry the authentication message 310 if the authentication response message 312 indicates a failure.

The client device, via the session control module 302 can initiate or receive requests to establish video conference sessions once the client device has authenticated itself with the network. The client session control module 302 can attempt to initiate a video conference session with a remote device by sending a call request 320 to the billing server. The billing server 304 sends the client session control module 302 an acknowledgement message that indicates whether the request was accepted or rejected.

Similarly, the client session control module 302 can receive a call request message from the billing server 304 indicating a remote device is requesting a video conference session. The client session control module 302 can then selectively send an acceptance or rejection. The client session control module 302 receives user input or automatic defaults that enable it to determine whether an acceptance or rejection message is to be sent.

After a call request has been accepted, whether by the client session control module 302 or a remote device, the video conference session can start. The client session control module 302 can send a start session message 330 immediately after receiving a call request acceptance. Alternatively, if the client session control module 302 does not send a start session message 330 within a predetermined period of time, the client session control module 302 defaults to send an abort session message 330 instead.

As the session starts, the source client begins transmitting encoded video and audio streams to the remote device and receives encoded video and audio streams from the remote device. However, a destination client device can be configured such that when a call request is accepted, the destination client device initially engages in a receive-only mode, or lecture mode. In the lecture mode, the destination client device that is the recipient of the call request receives the transmitted video and audio but does not transmit video or audio. The transmission of the video and audio signals can be inhibited in lecture mode. The destination client device can selectively decide to transmit at a later time by entering into a conference mode and terminating lecture mode. The destination client device can be configured to accept user commands to initiate transmission. Additionally, during an active video conference, a client device can “mute” the session. That is, the client device can selectively terminate transmitting the audio or video without terminating the video conference session.

Additionally, a single client device can simultaneously engage in video conferences with multiple remote devices. For simultaneous video conferences, there will be a new session instance for each connection to a remote device.

The encoded video and audio transmitted by the client device can be wirelessly transmitted at a very high data rate to ensure a high quality video conference session. For example, the client device can wirelessly transmit encoded video and audio at a rate of up to 6 Mbps or greater when the client device implements an IEEE 802.11a NIC and the network has the support bandwidth. In other video conference sessions, the client device can transmit encoded video and audio at a rate greater than 1 Mbps, 2 Mbps, 3 Mbps, 4 Mbps, 5 Mbps, or 6 Mbps. Similarly, the client device can receive and decode encoded video and audio streams that are received at a rate of greater than 1 Mbps, 2 Mbps, 3 Mbps, 4 Mbps, 5 Mbps, or 6 Mbps.

Once a video conference session has been started, the client or any of the remote devices connected to the video conference can elect to terminate the video conference session. The client session control module 302 of the originator client device can send a close session message 340 to the billing server 304 in order to terminate an active video conference session. Alternatively, the billing server 304 can send a close session message 340 to the client session control module 302 in response to a close session message generated by a remote device. Either message results in termination of the active video conference session. Once all active video conference sessions have been terminated, the client device can return to the authenticated state to wait for a call request or to initiate a call request. The client device can also choose to disconnect from the network.

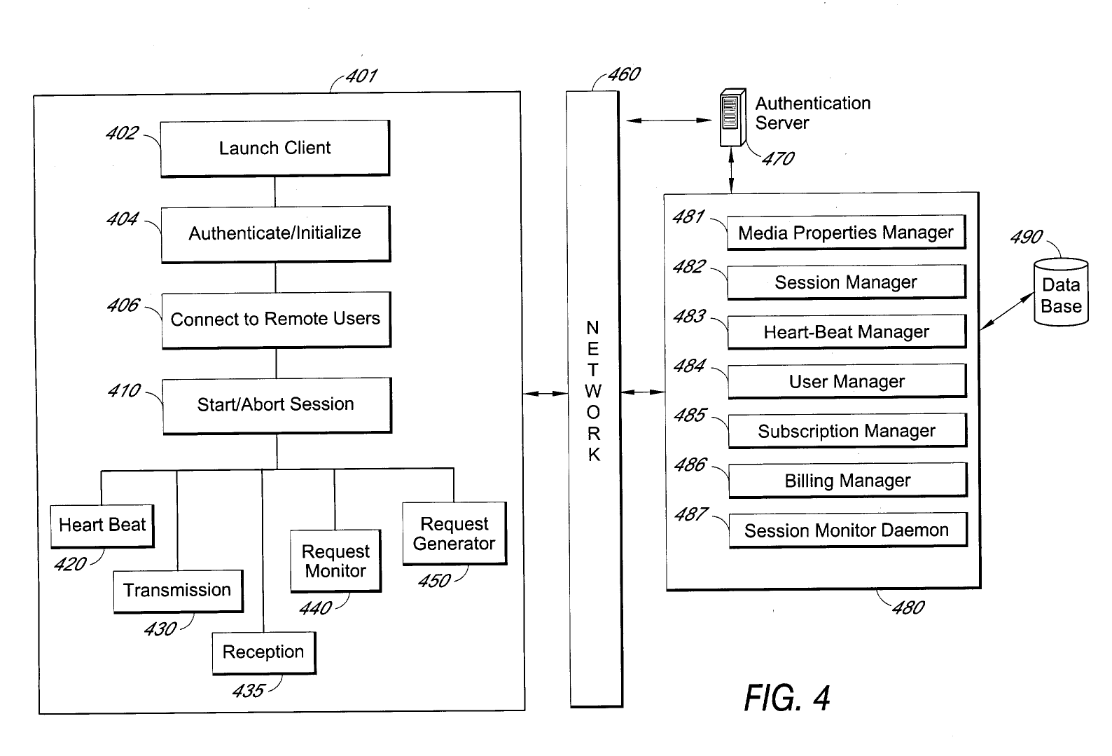

FIG. 4 is a functional block diagram of a client device 401 connected to a network 460 and servers 470, 480, and configured to provide a video conference session in accordance with the signal flow disclosed in FIG. 3. The connection between the client device 401 and the network 460 can include wireless communication links. The client device 401 can be, for example, the client device 202a of FIG. 2 or the client device 1521 of FIG. 15. The network 460 can be, for example, the network 110 of FIG. 1 or the network 1500 of FIG. 15.

The network 460 is also connected to an authentication server 470 and a billing server 480. The authentication server 470 can be distinct from the billing server 480 or the authentication server 470 can be part of the billing server 480. The authentication server 470 and the billing server 480 can also be servers that form a part of the BSMA server discussed in FIG. 1.

The authentication server 470 and the billing server 480 are also connected to a database 490 that can store client account data, billing data, system data, and other data. The database 490 can be configured to segregate the data used by each of the billing server 480 managers. Alternatively, the database can be organized by user, data type, or some other organization system.

The billing server 480 can include many dedicated managers. The billing server 480 can include a media properties manager 481. The media properties manager 481 can be used to manage the different types of media content that may be stored on other servers and made accessible to the client device 401. For example, the media properties manager 481 can maintain a database of on-line video content attributes, properties, or other information. The media properties manager 481 is typically not involved in a video conference session.

Additionally, the billing server 480 can include a session manager 482 that is configured to manage most of the processes associated with a video conference session. These processes can include, but are not limited to, notification of call requests to devices connected to the network 460, initialization of video conference sessions, start and abort video conference sessions, and termination of active video conference sessions.

The billing server 480 also includes a heartbeat manager 483 that is configured to track the heartbeat messages, or heartbeat signals, sent by the client device 401 while engaged in an active video conference. A user manager 484 included in the billing server 480 is configured to manage the user account information. Similarly, a subscription manager 485 is configured to manage user subscription data, including, but not limited to, level of access, type of subscription services accessible, quantity of time corresponding to pre-paid subscriptions, and the like. A billing manager 486 is configured to, for example, calculate bills, maintain client billing data, maintain client balance information, maintain client payment information, and the like.

A session monitor daemon 487 is configured as a background process to monitor the health of a video conferencing session, such as, but not limited to, client heartbeats, system heartbeats, and other time-out conditions. The session monitor daemon 487 is a process that can run continuously. The session monitor daemon 487 handles periodic service requests or updates that the system expects to receive. The session monitor daemon 487 can forward the requests to other processes.

A process running within the client device is detailed as a flowchart. Initially, a video conference application is launched in the client 402. Dedicated video conference devices can launch the client 402 immediately following power up as part of the initialization process. General purpose devices that include video conferencing as an available application can launch the client 402 in response to a command, that can be a user command or an automated command that occurs in response to a predetermined event.

After launching the client 402, the client device 401 authenticates 404 itself to the communication network. The client device 401 can authenticate 404 by sending an authentication/initialization message to the authentication server 470. The authentication/initialization message can include the MAC and IP address of the client device 401, and the user ID of the remote client device. The authentication server 470 searches the database 490 to determine whether or not the client device 401 should be provided access to the system. If the authentication/initialization message is valid, the session manager 482 sends a message indicating successful authentication and the remote client's IP address. If authentication is unsuccessful, the authentication server 470 sends a message indicating authentication failed. The client device can initialize the session when it receives the session ID from the session manager 482.

Provided the client device 401 has successfully authenticated and initialized the session, the client device 401 can connect to remote users 406. The client device 401 can request to be connected with remote client devices by sending a request with the remote device's IP address.

Because a typical user will not remember the IP addresses relating to remote devices, the client device 401 can be configured to store a directory of user IDs of corresponding devices. Alternatively, the client device 401 can be configured to access a directory of users stored in the database 490. The database can store a user directory with IP addresses for corresponding devices. A user can then select a user name from a directory and instruct the client device 401 to connect to the remote user 406. The user directory allows the connection message to contain any number of characters and codes that can identify a remote device without requiring direct user entry of the characters. In still another alternative, the client device can send a message having the user ID of a destination and one of the servers in the communication system can determine the corresponding destination device parameters.

The client device 401 transmits the request to the billing server 480 where the session manager 482 processes the request. The session manager 482 validates the request for the connection and provides the connection between the two authenticated clients. Once the client device 401 is connected with the remote device, a call request can be sent to the remote device.

The client device 401 can send a call request message to the session manager 482 that relays the request to the remote device. The call request can include the IP address, username, or other user ID of the remote device. Alternatively, the session manager 482 can use the IP address or identifying information transmitted by the client device 401 in the connection message to generate a call request to the remote device after the session manager 482 validates the connection request.

If the remote device accepts the call request, the session manager sends a message to the client device 401 indicating acceptance of the call request. Additionally, the session manager specifies a session identification and transmits the session identification to the client device 401.

The client device 401 can selectively start or abort the session 410 after initializing the session. To start the session, the client device 401 sends a start session request to the session manager 482. The start session request marks the beginning of the video conference. The session manager 482 communicates the start of the video conference to the heartbeat manager 483 and the billing manager 486 to allow billing of the provided service.

Alternatively, the client device 401 can selectively abort the session instead of starting a video conference. The client device 401 can send an abort message to the session manager 482 to abort the session. Alternatively, the session monitor daemon 487 can automatically abort the session if a start message has not been received within a predetermined period of time. The session monitor daemon 487 can use a predetermined abort timeout to ensure that valid session ID's do not persist for stale session requests.

The client device 401 spawns a number of threads simultaneously after a valid video conference session has started. Each of the threads can be configured to run on the processor and utilize or control elements shown in FIG. 2 to accomplish the described functions.

The client device 401 executes a heartbeat thread 420 to periodically send a heartbeat signal to the heartbeat manager 483. The heartbeat thread continues to send the heartbeat signal at a periodic basis provided the heartbeat manager 483 provides a confirmation that the heartbeat signal was sent successfully. If the heartbeat is not received in a timely manner, the session monitor daemon 487 stops the session.

The client device 401 executes a transmission thread 430 simultaneously with the heartbeat thread 420. The transmission thread 430 controls the process associated with capturing video and audio, encoding the captured video and audio, transmitting the encoded signals. The transmission thread 430 is stopped if the user stops the video conference. A close session message is sent to the session manager 482 to indicate the client device 401 is terminating the valid session.

The client device 401 executes a reception thread 435. The reception thread 435 controls the process of decoding received signals, resynchronizing the received audio and video, and outputting the resynchronized audio and video. The reception thread 435 is stopped if the user stops the video conference.

Additionally, the client device 401 executes a request monitor thread 440 and a request generator thread 450. The client device 401 is able to simultaneously request video conference sessions with multiple remote devices. Additionally, the client device 401 can receive requests for video conference sessions from remote devices while already engaged in an active video conference.

The request monitor thread 440 listens for call requests from remote devices sent by the session manager 482. The request monitor 440 allows the user to indicate a call request acceptance or call request rejection.

Similarly, the request generator thread 450 sends call requests to the session manager 482 directed to other remote devices. The call request message is sent by the client device 401 to the session manager 482. The session manager 482 sends the call request to the remote device and awaits the response. The response is received by the session manager 482 and is forwarded to the client device 401. An additional video conference can then be started. Any client connected to a video conference can close the session associated with their device.

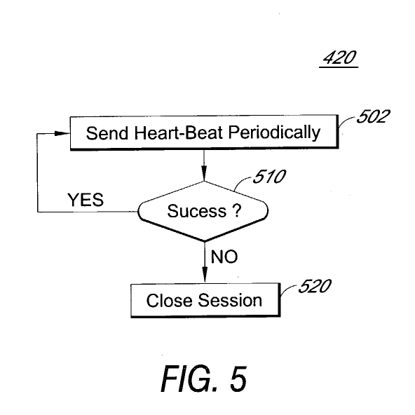

FIG. 5 is a flowchart providing further detail of the heartbeat thread 420 of FIG. 4. The heartbeat thread 420 begins by periodically sending a heartbeat signal 502. The heartbeat signal can, for example, be configured as an Extensible Markup Language (XML) message using Hyper Text Transfer Protocol (HTTP). An XML message can be used to allow the heartbeat signal to pass through network firewalls, or to allow authentication of the heartbeat signal.

After sending the heartbeat signal, the heartbeat thread waits for an acknowledgement message from the heartbeat manager in the billing server. The heartbeat thread 420 determines, at decision block 510, whether the response received from the heartbeat manager indicates success or failure of the heartbeat signal. Alternatively, a timeout of the heartbeat signal can indicate a failure. If the heartbeat thread determines the heartbeat signal was successfully received by the heartbeat manager, the heartbeat thread 420 returns to block 502 to wait for the next instance to send the heartbeat signal. For example, the heartbeat thread 420 can send a heartbeat signal every 30 seconds that the client device is engaged in an active video conference session.

However, if the heartbeat thread 420 determines that the heartbeat signal was not successfully received by the heartbeat manager, the heartbeat thread 420 proceeds to close the session 520. There may be a number of reasons for an unsuccessful heartbeat signal. For example, the communication link from one of the clients in the video conference can drop, or the heartbeat signal was corrupted, the heartbeat signal was not sent, or the like.

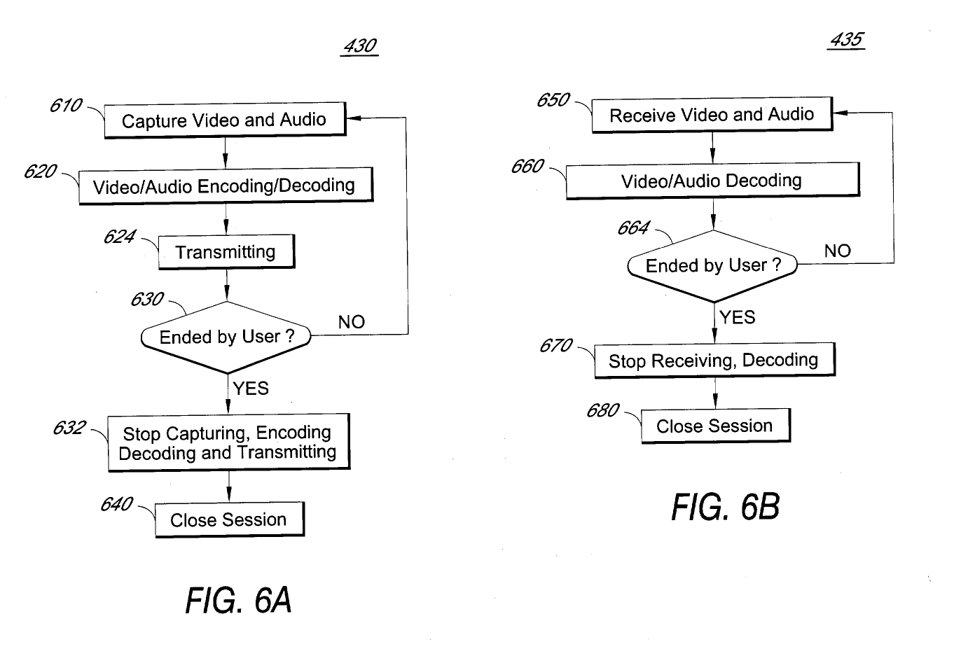

FIG. 6A is a flowchart providing further detail of the transmission thread 430 of FIG. 4. The transmission thread can be configured as processor readable instructions stored in memory and can instruct the processor to utilize or control the elements in FIG. 2. The transmission thread 430 performs capture of the video and audio 610 that is local to the client. The transmission thread 430 then performs encoding of the captured video and audio signals 620. Additionally, the transmission thread 430 performs decoding of video and audio. The video and audio that are decoded include the video and audio in loopback rendering as well as encoded video and audio received from remote devices.

After the locally generated video and audio are encoded, the transmission thread 430 proceeds to block 624 where the encoded streams are transmitted over the network to the destination devices. The transmission thread 430 also checks, in decision block 630, whether the video conference session has been ended by a user.

If the video conference session has not been ended, the transmission thread 430 returns to block 610 and continues to capture video and audio. However, if the video conference session is ended by the user, the transmission block proceeds to block 632 where video and audio capturing are terminated. Additionally, decoding of captured and encoded video and audio, as well as decoding of received video and audio, are stopped. Once the capture, encoding, and decoding processes are stopped, the transmission thread closes the session 640.

FIG. 6B is a flowchart providing further detail of the reception thread 435 of FIG. 4. The reception thread 435 receives the packetized audio and video 650 that are sent by the remote devices. Additionally, the reception thread 435 can receive loopback packetized audio and video that are generated local to the client device. The loopback audio and video can be provided through a path in the NIC shown in FIG. 2. The NIC can transmit the video and audio to the network and can also be configured to route the signals to a loopback path to the receive stream controller within the client device.

The reception thread then performs video and audio decoding 660 of the received packets. The reception thread 435, in decision block 664, also checks to see if the session has been ended by a user. If not, the session remains active and the reception thread 435 returns to block 650 to continue to receive video and audio packets.

If, in decision block 664, the session is ended by a user, the reception thread 435 proceeds to block 670 where the reception thread 435 stops receiving and decoding the packetized audio and video. The reception thread 435 then proceeds to block 680 to close the session 680.

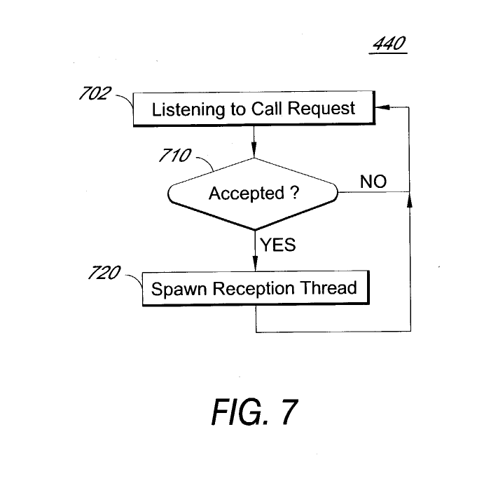

FIG. 7 is a flowchart providing further detail of the request monitor thread 440 of FIG. 4. The request monitor thread 440 initially listens for call requests 702 originating at remote devices and transmitted by the session manager to the client device. If a call request is received, the request monitor thread 440 proceeds to decision block 710 where the thread awaits a user response to the call request.

If the user rejects the call request, either a rejection message may be sent to the session manager, or the client device can ignore the call request. After rejecting call requests, the thread returns to listen for call requests 702.

The client device can be configured to provide a preview of the source video to allow the user to see the source video prior to accepting the call request. The preview of the source video can be limited to a predetermined limited period of time, for example, 5 seconds. The preview can be enabled when the source video is transmitted by the initiator of the call request during the pendency of the call request.

Alternatively, if a call request is accepted, the request monitor thread proceeds to block 720 where the client device begins receiving video and audio streams and decodes the new received video and audio streams. This may be performed, for example, by initiating an additional reception thread.

Once the active video conference is ended by the user, the reception thread can return to block 702 of the request monitor thread 440 to continue to listen to call requests. Alternatively, the request monitor thread 440 can terminate. The overall client process, which can run within the session control module, can in some instances restart the request monitor thread 440 to continue monitoring for new call requests. Alternatively, the overall client process can start a new request monitor thread 440 once a request monitor thread enters an active video conference.

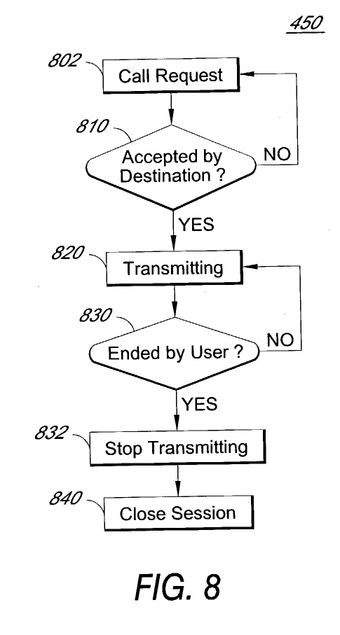

FIG. 8 is a flowchart providing further detail of the request generator thread 450 of FIG. 4. The request generator thread 450 begins by generating a call request 802 to set up a video conference with a remote device. The request generator thread 450 then determines if the request was accepted by the destination device 810. A transmission thread, as shown in FIG. 6A, can run concurrently with the request generator thread such that a video and/or audio stream can accompany the call request. Running the transmission thread concurrent with the request generator thread enables a destination device to view a preview of the source video prior to accepting the call request.

If the call request is rejected, the request generator returns to block 802 where a call request can again be sent. Alternatively, the overall client process can terminate the call request thread 450 if the call request is rejected.

If a call request is rejected, the source device can push a message onto the destination device if the destination device is in communication with the source device and if the destination device is configured to accept and store messages in memory. The message can be video and/or audio or other types of data. For example, The destination device can be configured similar to an answering machine during periods that it is in communication with the network. The source device can receive a rejection message from a destination device in response to a call request and can then push a video and audio stream to the destination device. The destination device can store the message in memory for later retrieval.

If the call request is accepted by the remote destination device, the call request thread 450 proceeds to block 820 to begin transmitting the video and audio streams to the remote device. For example, the request generator 450 can initiate another transmission thread.

After initiating transmission, the request generator monitors to see if the video conference is ended by the user 830. While the conference remains active, the client device continues to transmit the video and audio streams as well as decode received video and audio streams. If the request generator 450 determines that the video conference is ended, the thread proceeds to block 832 where transmission of the video and audio thread are stopped. For example, the transmission thread corresponding to the video conference can be stopped. After stopping transmission of the video and audio streams, the request generator thread 450 proceeds to block 840 where the session is closed. The overall client process can choose to restart a request generator thread or can choose to not initiate another request generator thread. Additionally, the overall client process can initiate a request generator thread while another request generator thread is running.

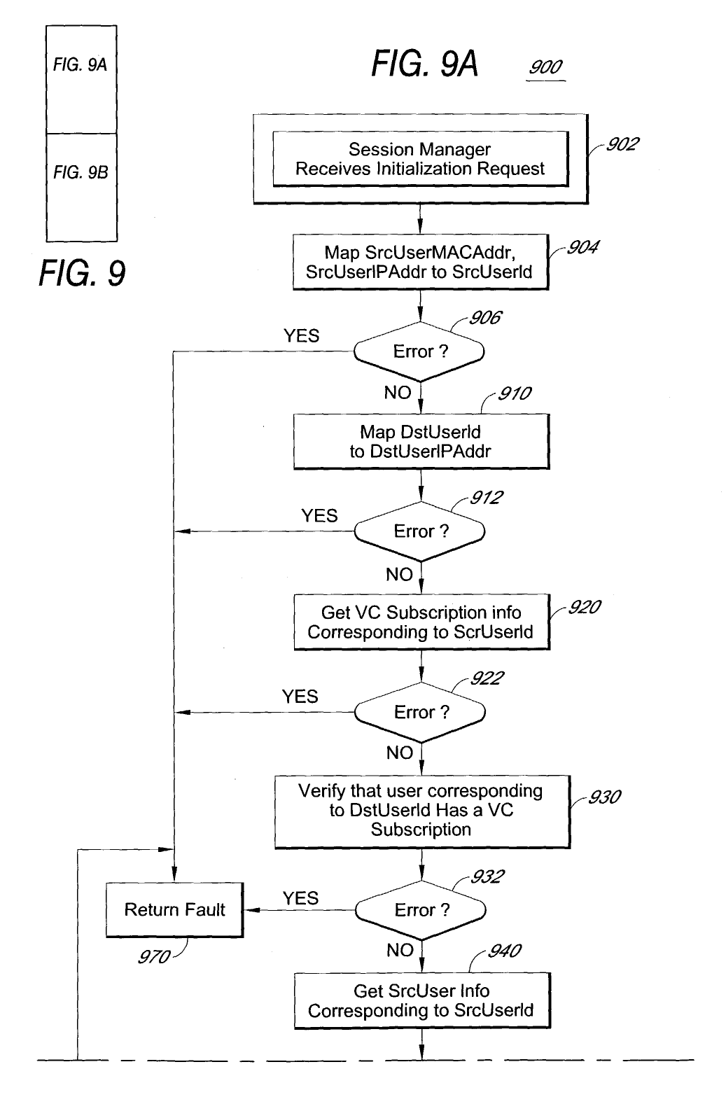

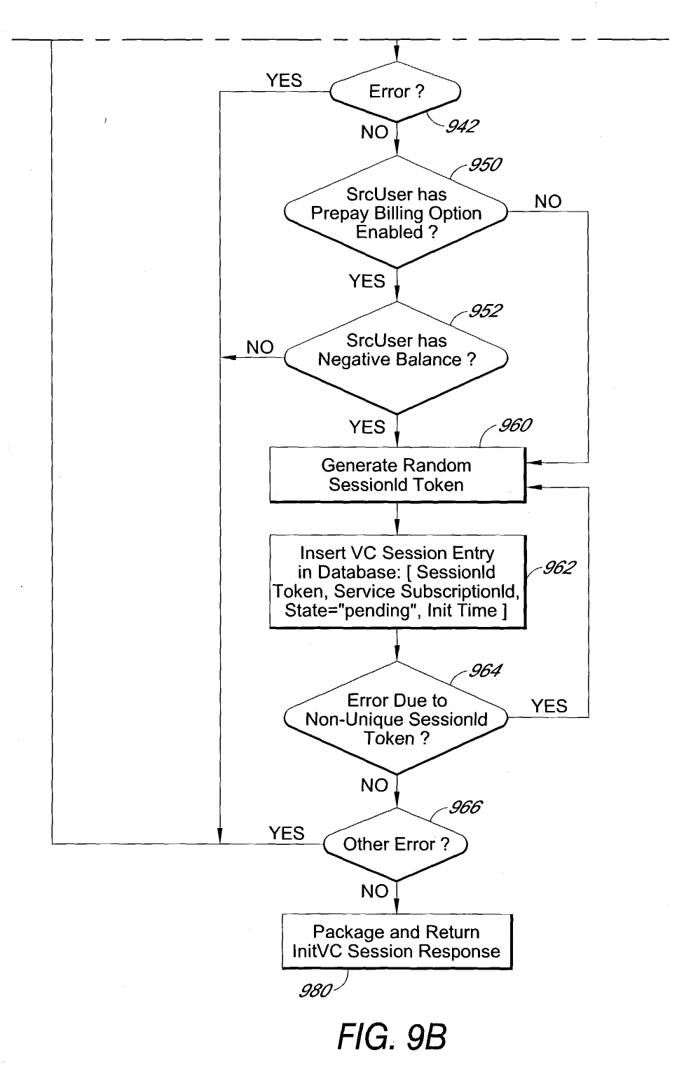

FIGS. 4 through FIG. 8 focus on the processes operating within the client device. Similar processes operate on the servers connected to the network in order to interface with the clients. FIG. 9 is a flowchart of a session initialization process 900 that can be configured within the session manager.

The session initialization process 900 begins when the session manager receives a video conference initialization request 902. The initialization request can contain a variety of parameters. In one embodiment, the initialization request includes the MAC address, IP address of the source client device, and user ID of the destination client device. The session manager next identifies the user based on message parameters. The session manager maps the MAC address and IP address of the message source 904 to data stored in a database accessible to the server hosting the session manager. The session manager also maps the user ID of the destination device to what is stored in the database.

The session manager next checks in decision block 906 to see if the database map returned an error. An error may occur, for example, if the MAC address and IP address do not map to a user ID that is stored in the database. In still another example, an error may occur if the destination user ID is invalid.

If an error is returned after mapping the initialization request, the session manager proceeds to block 970 where a fault message is returned to the source client device. The fault message can include a fault ID that identifies the type of fault encountered and can also include an error message that can be displayed on a display of the client device.

If the initialization request does not result in an error, the session manager proceeds to map the destination user ID to a destination IP address. The session initialization process 900 is configured to allow the client device to send only the destination user ID. Thus, the session manager in this embodiment performs the task of mapping the destination user ID to the destination IP address. The session manager performs this mapping in block 910. The database is examined for the destination user ID and the corresponding destination IP address is retrieved from the database.

The session manager next proceeds to decision block 912 to determine if the mapping of the destination user ID resulted in an error. An error can occur, for example, if there is no IP address associated with the destination user ID, if the destination user ID corresponds to an account that is no longer valid, or if there is no database entry for the destination user ID.

If an error occurs, the session manager proceeds to block 970, as before, where a fault message is transmitted to the source client device. If no error occurred, then the session manager proceeds to block 920 where the video conference subscription information corresponding to the source user ID is retrieved from the database.

The session manager next proceeds to decision block 922 to determine if an error occurred. An error in retrieving the video conference subscription information can occur, for example, if there is no subscription information in the database. Again, the session manager proceeds to block 970 to transmit a fault message to the source device if an error occurs.

The session manager then proceeds to block 930 if no error occurred. The session manager, in block 930, verifies that the user corresponding to the destination user ID has a video conference subscription. This verification can be particularly useful in systems that are configured to provide more services than just video conferencing. The session manager proceeds to decision block 932 to determine if an error occurred. An error can occur, for example, if the destination device does not have any subscription information in the database. Again, if an error occurs, the session manager proceeds to block 970 to transmit a fault message to the source device.

If no error occurred, the session manager proceeds to block 940 where the source user information is retrieved from the database. The session manager proceeds to decision block 942 to determine if an error occurred. An error can occur, for example, if the source device does not have sufficient subscription information in the database. Again, if an error occurs, the session manager proceeds to block 970 to transmit a fault message to the source device.

If no error occurred, the session manager evaluates the retrieved data. In addition to the MAC address of the client device, the user data associated with a user ID can include the IP address of the client device, a payment option, and an account balance. The payment option can be chosen from a predetermined list of payment options. The available payment options can, for example, include automatic payment, prepayment, or some other payment option.

The session manager, in decision block 950, determines if the source user has a prepay billing option enabled. If so, the session manager proceeds to decision block 952 to determine if the account contains a negative balance. If the source user does not have a negative balance there is a balance due on the account and further accrual of balance can be prevented by refusing additional video conferences. Thus, if the source user does not have a negative balance, the session manager proceeds to block 970 to return a fault message to the source client.

However, if the source user has a negative balance, or the source user does not use the prepay billing option, the session manager proceeds at block 960. At block 960 the session manager generates a random session ID token to be used with the video conference session. The session manager then proceeds to block 962 where the details of the video conference session are stored in the database.

The video conference session data stored in the database can include, but is not limited to, the session ID token, the service subscription ID, the destination user ID, a state of the video conference, an initialization time, a heartbeat time, an abort time, an abort reason, a start time, an end time, and an end reason. There can be other data stored in the database. The possible states for the video conference session include pending, aborted, active, and terminated. The initial state of the video conference can be stored as “pending” to note that the source device has not yet started the video conference.

The service subscription ID can include such information as a subscription identifier, a user identifier, and a usage rate for the user. Other information can also be stored as part of the service subscription ID.

The session manager then checks to see if there is an error due to a non-unique session ID token. Because the session ID token is randomly generated, there is the possibility that the value will not be unique. If the value is found to be non-unique the session manager returns to block 960 where another random session ID token is generated. Although the blocks in the session initialization process 900 can be performed in exactly the order shown in FIG. 9, other embodiments can use alternative orders. For example, the session manager can perform block 964 prior to block 962 such that the check for non-unique session ID token is performed prior to storing the details of the video conference session in the database.

After determining a unique session ID token, the session manager proceeds to decision block 966 to check to see if any other errors have occurred. As before, an occurrence of an error results in the session manager proceeding to block 970 to return a fault message to the source device. If no other errors have occurred, the session manager proceeds to block 980 where the session manager packages and returns an initialize video conference session response. The response can, for example, include the session ID token and the IP address of the destination client device.

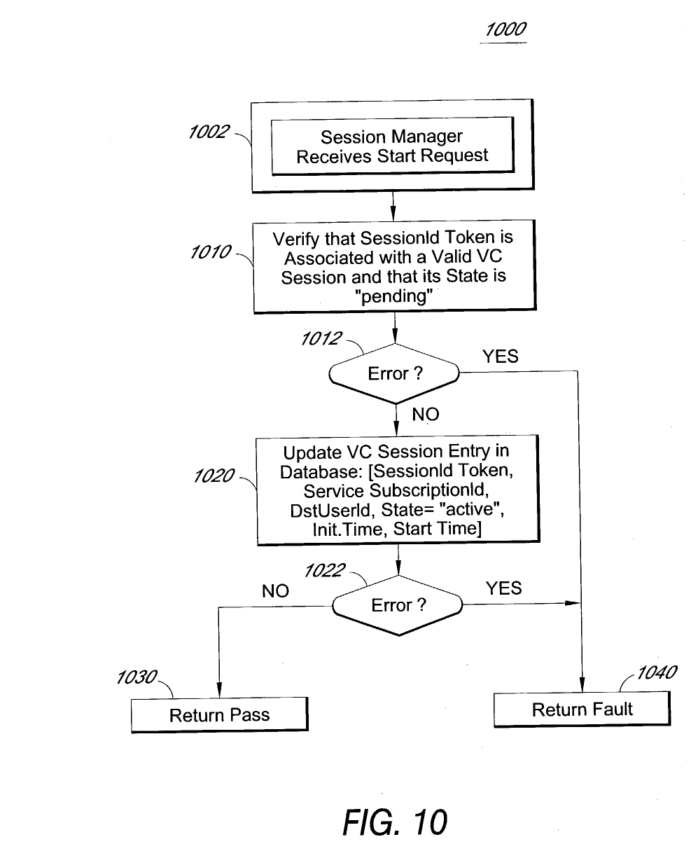

The source client can choose to start the video conference after successful initialization of the session. FIG. 10 is a flowchart of a session start process 1000 that can be performed in the session manager to control the start of a video conference session.

The session start process 1000 begins when the session manager receives a start request message 1002 from the source client. The start request message can include, for example, the session ID token used to identify the video conference session.

After the session manager receives the start request message 1002, the session manager proceeds to block 1010 where the session manager verifies that the session ID token is associated with a valid video conference session. The session manager also checks to see that the current state of the video conference is “pending.” The session manager performs this check by accessing the database where the video conference data is stored.

The session manager next proceeds to decision block 1012 to determine if the verification produced any errors. An error can occur, for example, if the session ID token provided is no longer valid or if the session is currently active, rather than pending. If an error occurs, the session manager proceeds to block 1040 where a fault message is generated and returned to the source client. As was the case for the process detailed in FIG. 9, the fault message can contain a fault identifier and an error message that can be displayed at the source device.

Returning to block 1012, if the session manager determines the verification does not produce errors, the session manager proceeds to block 1020. In block 1020, the session manager updates the previously stored video conference session entries in the database. The video conference session entries include, for example, the session ID token value, the service subscription identification, the state of the video conference, the initialization time, and the start time. The session manager typically updates the video conference state to “active” and stores a video conference start time. The other data entries typically are not modified at this time.

After updating the video conference session entries in the database, the session manager proceeds to decision block 1022 where the session manager checks to see if the update process produced any errors. An error can occur, for example, if the session manager is unable to access the database entries. If an error occurs, the session manager proceeds to block 1040 where a fault message is generated and returned to the source client. If no error occurs, the session manger proceeds to block 1030.

In block 1030, the session manager returns a pass message to the source client. The pass message acknowledges the start message sent by the source client was successfully processed.

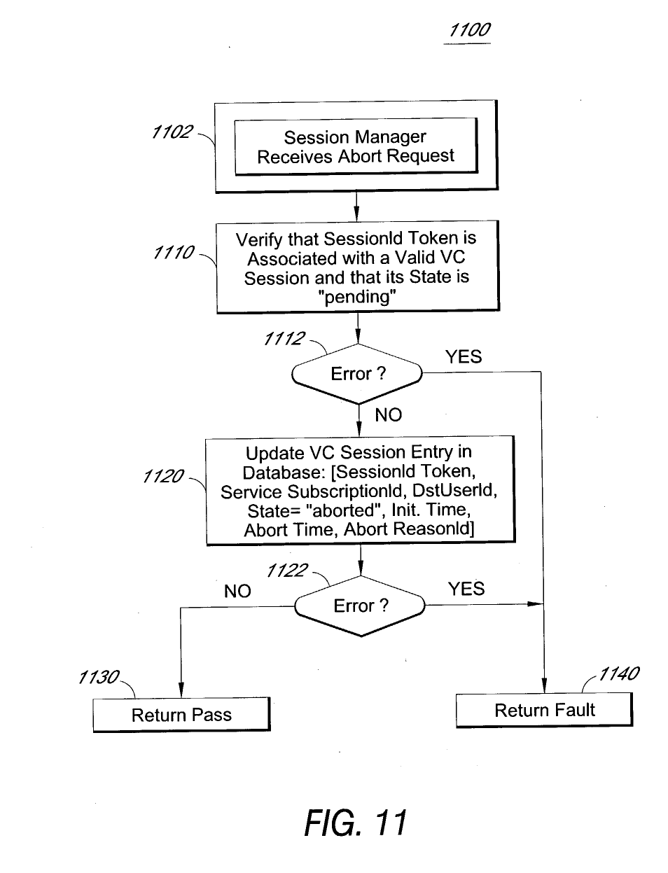

Although the source client can choose to start a video conference session after initialization, the source client can also choose to abort the previously initialized video conference session. FIG. 11 is a flowchart of an abort session process 1100 performed by the session manager. The session manager performs the abort session process 1100 in response to an abort message sent by the source client.

Initially, the session manager receives an abort request message 1102 from the source client. The abort request message includes a session ID token and a reason for aborting the session. The reason for aborting the session can be selected from a predetermined list of reasons. The predetermined list of reasons can include, for example, no response received from the destination device, connection timeout, or some other reason. Each of the predetermined reasons can be assigned a reason ID. The abort request message can then include the reason ID rather than the actual reason for requesting to abort the session. After receiving the abort request message, the session manager proceeds to block 1110 to begin processing the message.

At block 1110 the session manager verifies that the session ID token is associated with a valid video conference session. The session manager also verifies the state of the video conference session is “pending.” The session manager verifies the data by accessing the database for the stored video conference session data. The session manager then proceeds to block 1112 to check to see if the verification process produced errors.

An error can occur, for example, if the session ID token provided is no longer valid or if the session is currently active, rather than pending. If an error occurs, the session manager proceeds to block 1140 where a fault message is generated and returned to the source client. The fault message can contain a fault identifier and an error message that can be displayed at the source device.

Returning to block 1112, if the session manager determines the verification does not produce errors, the session manager proceeds to block 1120. In block 1120, the session manager updates the previously stored video conference session entries in the database. The video conference session entries include, for example, the session ID token value, the service subscription identification, the state of the video conference, the initialization time, an abort time, and an abort reason.

The session manager updates the video conference state to “aborted” and stores a video conference abort time in response to the abort request message. Additionally, an abort reason is included in the video conference session entries. The abort reason can be stored as an abort reason ID. The other data entries typically are not modified at this time.

After updating, or attempting to update, the video conference session entries in the database, the session manager proceeds to decision block 1122 where the session manager checks to see if the update process produced any errors. An error can occur, for example, if the session manager is unable to access the database entries. If an error occurs, the session manager proceeds to block 1140 where a fault message is generated and returned to the source client. If no error occurs, the session manger proceeds to block 1130.

In block 1130, the session manager returns a pass message to the source client. The pass message acknowledges the session manager successfully processed the abort request message sent by the source client.

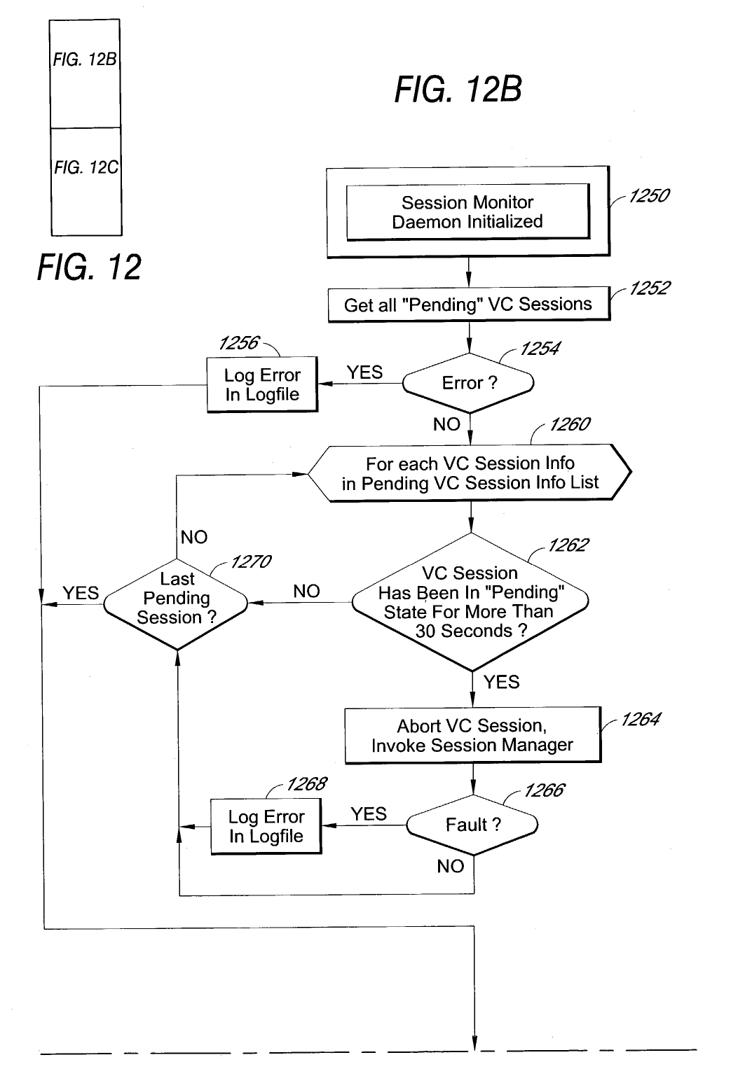

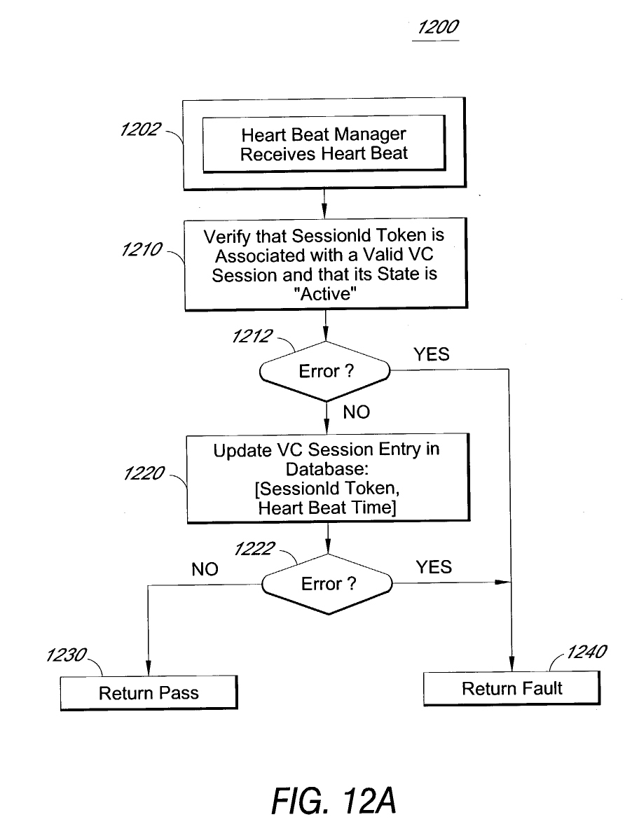

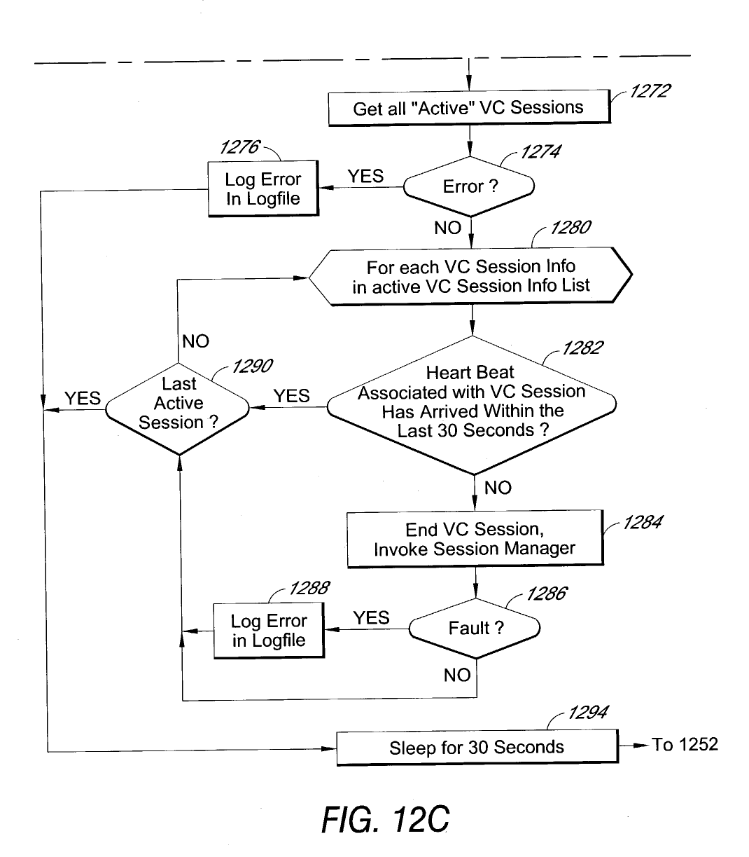

After a source client has started the video conference, the source client periodically transmits a heartbeat signal to the heartbeat manager to maintain the active session and to assist in the billing of the video conference session. FIG. 12A is a flowchart of the heartbeat management process 1200 performed by the heartbeat manager in response to a heartbeat signal transmitted by the client device.

The heartbeat management process 1200 begins at block 1202 when the heartbeat manager receives a heartbeat signal from the client device. The heartbeat signal can include, for example, the session ID token associated with the video conference session. After receiving the heartbeat signal, the heartbeat manager proceeds to block 1210 to begin processing the signal.

In block 1210 the heartbeat manager verifies that the session ID token is associated with a valid video conference session. The heartbeat manager also verifies the state of the video conference session is “active.” The session manager verifies the data by accessing the stored video conference session data in the database. The session manager then proceeds to block 1212 to check to see if the verification process produced errors.

An error can occur, for example, if the session ID token provided is not valid or if the session is currently pending, rather than active. If an error occurs, the heartbeat manager proceeds to block 1240 where a fault message is generated and returned to the source client. The fault message can contain a fault identifier and an error message that can be displayed at the source device.

Returning to block 1212, if the heartbeat manager determines the verification does not produce errors, the heartbeat manager proceeds to block 1220. In block 1220, the heartbeat manager updates the previously stored video conference session entries in the database. The video conference session entries include, for example, the session ID token value, the service subscription identification, the state of the video conference, the initialization time, and a heartbeat time. The heartbeat manager updates the heartbeat time while typically leaving the other data entries unchanged.

After updating, or attempting to update, the video conference session entries in the database, the heartbeat manager proceeds to decision block 1222 where the heartbeat manager checks to see if the update process produced any errors. An error can occur, for example, if the heartbeat manager is unable to access the database entries. If an error occurs, the heartbeat manager proceeds to block 1240 where a fault message is generated and returned to the source client. If no error occurs, the heartbeat manager proceeds to block 1230.

In block 1230, the heartbeat manager returns a pass message to the source client. The pass message acknowledges the heartbeat manager successfully processed the heartbeat signal sent by the source client.

FIGS. 12B-12C are flowcharts of a background process performed by the session monitor daemon. The session monitor daemon can be, for example, the session monitor daemon of FIG. 4.

The process begins at block 1250 when the session monitor daemon is initialized. The process, in block 1252, begins by retrieving the session data entries for all pending video conference sessions from the database. The process then proceeds to decision block 1254 to determine if the retrieval process resulted in any errors.

If decision block 1254 determines that one or more errors occurred, the process proceeds to block 1256 where the errors are logged in a logfile, which can also be stored in the database. The process proceeds from block 1256 to block 1272 in FIG. 12C discussed below.

If decision block 1254 determines that errors did not occur, the process proceeds to block 1260 where the process enters a loop to be performed for each group of video conference session data entries previously retrieved. The loop begins in decision block 1262 where the process determines whether the video conference session has remained in the pending state for more than a predetermined period of time, for example, 30 seconds.

If the session has not been pending for more than 30 seconds, the process proceeds to decision block 1270 to determine whether the session just analyzed was the last of the pending sessions retrieved from the database. If so the process exits from the loop and proceeds to block 1272 in FIG. 12C. If the retrieved session was not the last pending video conference session, the process returns to block 1260 to examine the data for the next pending session.

Returning to decision block 1262, if it is determined that the video conference session has been pending for more than 30 seconds, the process proceeds to block 1264 where an abort session request message is generated and communicated to the session manager. The process, in block 1264 waits to receive a pass or fault indication from the session manager.

The process next proceeds to decision block 1266 to determine if the session manager indicated a fault. If not, the process proceeds to decision block 1270 to determine if the data for the last pending session has been analyzed. If, in decision block 1266, a session manager fault is indicated, the process proceeds to block 1268 where the error corresponding to the session manager fault indication is stored in the logfile. From block 1268, the process proceeds to block 1270 to determine if the data for the last pending session has been analyzed.

Once all of the pending video conference sessions have been examined, the process proceeds to block 1272, shown in FIG. 12C. In block 1272, the process retrieves, from the database, the session data entries for all of the active video conference sessions. The process next proceeds to decision block 1274 to determine if the retrieval process resulted in an error.

If an error occurred, the process proceeds to block 1276 to log the error in the logfile. If no error occurred, the process proceeds to block 1280 where the process enters a loop to be performed for each group of video conference session data entries previously retrieved.

The process proceeds to decision block 1282 to determine if the heartbeat associated with the active video conference session has arrived within a predetermined period of time, for example, 30 seconds. The periodic arrival of a heartbeat signal indicates an active video conference session remains operational. Thus, if the heartbeat signal arrived within the predetermined period of time, the process proceeds to block 1290 to determine if the data for the last active session has been analyzed.

If, in decision block 1282, it is determined that the heartbeat signal has not arrived within a predetermined period of time, the process proceeds to block 1284 where an end video conference session message is generated and communicated to the session manager. The process then waits for the session manager response, which can be a pass or a fail acknowledgement message.

The process proceeds to decision block 1286 after receiving the acknowledgement message from the session manager. The process determines if the acknowledgement message indicates a pass or fail. If a pass is indicated, the process proceeds to decision block 1290 to determine if the data for the last active video conference has been analyzed. Alternatively, if a fail is indicated, the process proceeds to block 1288 to log the error in the logfile. The process then proceeds to decision block 1290 to determine if the data for the last active video conference has been analyzed.

In decision block 1290, the process determines if the data for the last active video conference session has been analyzed. If not, the process remains in the loop and returns to block 1280 to examine the session data for the next video conference session. Alternatively, if the session data analyzed was the final session data, the process exits the loop and proceeds to block 1294 where the process sleeps, or waits, for a predetermined period of time before returning to block 1252 to resume analyzing the session data. The predetermined period of time can be, for example, 30 seconds to coincide with the time periods used in the determining if a pending session or an active session should be terminated. Thus, by returning to block 1252, the process periodically monitors the health of all pending and active video conference sessions.

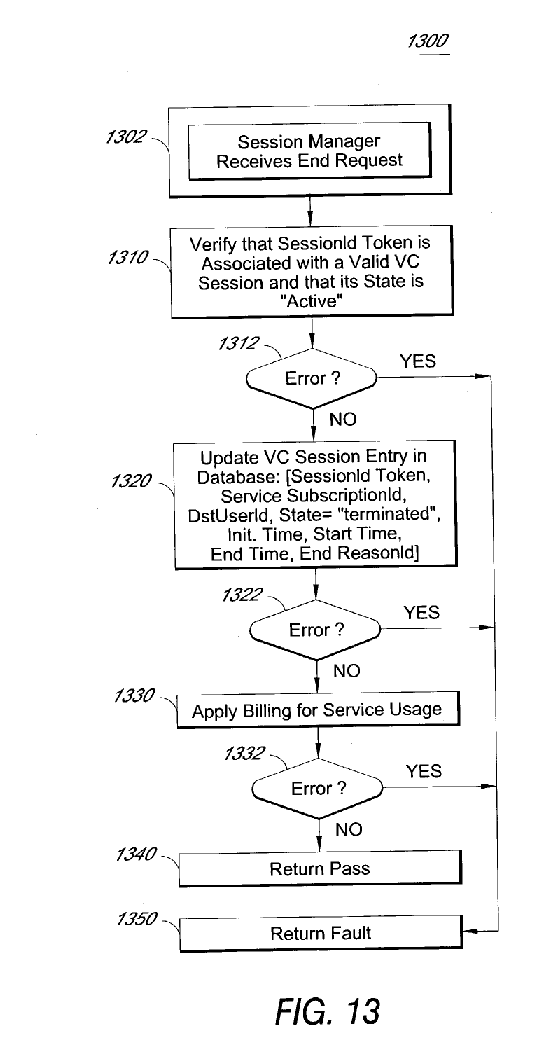

An active video conference connects two or more client devices and exchanges the video and audio streams between them. Any one of the clients connected to the session can request termination of the session. FIG. 13 is a flowchart of a session end process 1300 performed by the session manager. In the session end process 1300, the session manager receives an end session request message, or termination message, and processes it to end the active video conference session and to calculate the bill for the video conference session.

The session end process 1300 begins when the session manager receives an end session request message 1302. The end session request message includes, for example, the session ID token and a reason for ending the session. The reason for ending the session can include, for example, a source client termination, a destination client termination, a connection lost, or some other reason. The reason for terminating the session can be included as a reason ID in the end session request message.

After receiving the message, the session manager proceeds to block 1310 to begin processing the message. In block 1310, the session manager verifies the session ID token is associated with a valid video conference session and that the state of the video conference session is “active.” The session manager then proceeds to decision block 1312.

In decision block 1312, the session manager determines if the verification process resulted in any errors. An error can occur, for example, if the session ID token is not valid or if the video conference session is not currently active. If an error is discovered, the session manager proceeds to block 1350 where a fault message is generated and transmitted to the client that originated the end session request message.

Returning to decision block 1312, if the session manager does not discover an error during the verification process, the session manager proceeds to block 1320. In block 1320 the session manager updates, or attempts to update, the video conference session entries in the database. As before, the video conference session entries can contain the session ID token, the service subscription ID, the destination user ID, the state of the video conference session, the initialization time, the start time, the end time, and an end reason. The session manager can update the state of the video conference session to “terminated”, update the end time of the session, and update the end reason by storing an end reason ID. The session manager then proceeds to block 1322 to determine if any errors occurred during the update process.

If an error occurred, the session manager proceeds to block 1350 to generate a fault message and transmit it to the client requesting to end the session. If no error occurred, the session manager proceeds to block 1330 to determine and apply billing for the service usage. The session manager then proceeds to block 1332 to determine if any errors occurred during the billing process.

If an error occurred, the session manager proceeds to block 1350 to generate a fault message and transmit it to the client requesting to end the session. If no error occurred, the session manager proceeds to block 1340 where an acknowledgement message is generated and sent to the requesting client. The acknowledgement message can indicate the end session request message was successfully processed by the session manager.

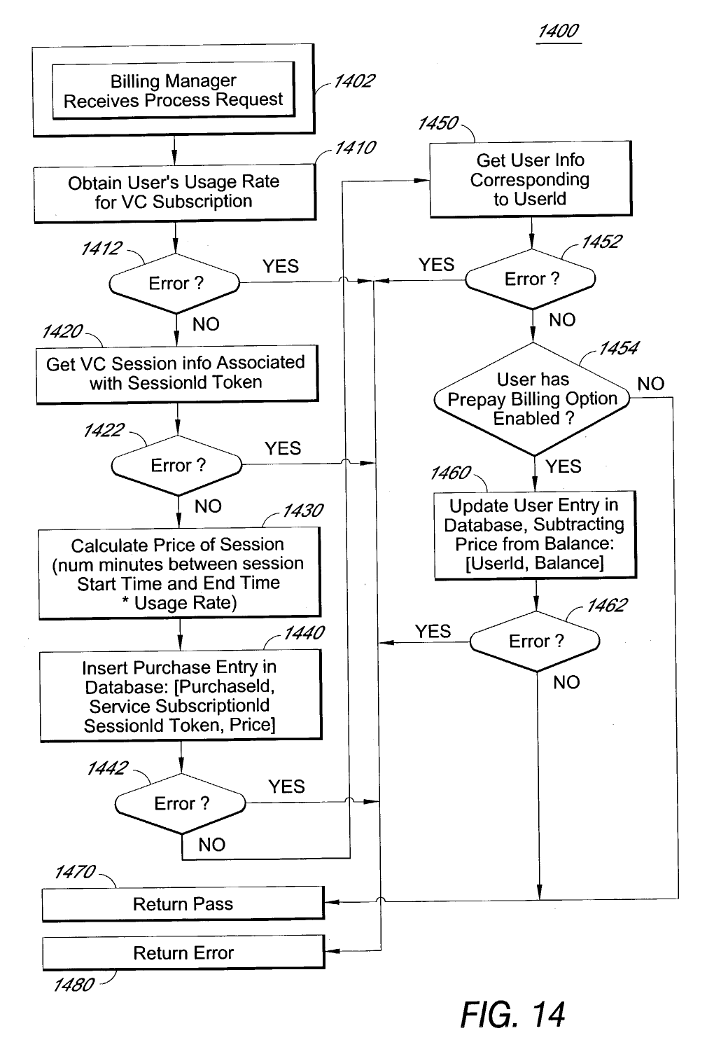

As detailed in the flowchart of FIG. 13, the session manager applies the billing for the service usage when the video conference session is terminated. FIG. 14 is a flowchart of a billing process 1400 that is initiated by the session manager when billing is to be applied for the service usage. When a bill for a video conference session is to be determined, the session manager communicates a billing request to the billing manager. These managers can part of the billing server shown in FIG. 4, which can be an element of the BSMA server shown in FIG. 1. The billing manager then performs the billing process to determine a price of the video conference session.

The billing process 1400 determines a price of the video conference session that is applied to the source client's account. That is, the billing process 1400 uses a billing model wherein the source client is billed for any video conferences initiated and the destination client is not billed for accepting a request for a video conference. This billing model tracks a typical phone billing model in that the calling party is the one that is charged for the service. Of course, other billing models can be implemented in the video conference system, and the system is not limited to the billing process 1400 of FIG. 14. For example, distributed billing can be implemented or collect call billing can be implemented by the billing process.

The billing process 1400 begins at block 1402 when the billing manager receives a process service usage request message, or billing request message, from the session manager. The billing request message can be generated by the session manager during the session end process. For example, the session manager can generate the billing request message when the session manager applies the billing for the video conference session. The billing request message can include the session ID token of the video conference session.

After receiving the request, the billing manager proceeds to block 1410 where the billing manager retrieves from the database the source client's usage rate for the video conference subscription. The usage rate can be stored in the database in a location identified with the source client's user ID. The usage rate data can, for example, represent a cost associated with a cost per minute of active video conference session or each heartbeat count.

The billing manager next proceeds to decision block 1412 to determine if any errors occurred as a result of the data retrieval operation. If an error occurred, the billing manager proceeds to block 1480 to generate an error message and transmit it to the session manager. If no error occurred, the billing manager proceeds to block 1420.

In block 1420, the billing manager accesses the database and retrieves the video conference session information associated with the session ID token. The video conference session information can include some or all of the video conference entries updated by the session manager throughout the video conference session.

The billing manager next proceeds to block 1422 to determine if any errors occurred as a result of the data retrieval operation. If an error occurred, the billing manager proceeds to block 1480 to generate an error message and transmit it to the session manager. If no error occurred, the billing manager proceeds to block 1430 to continue processing the bill.

In block 1430, the billing manager calculates, or otherwise determines, the price of the video conference session. For example, the billing manager can calculate the number of minutes between the start time and the end time and multiply the number of minutes by the usage rate.

Once the price of the session is calculated, the billing manager proceeds to block 1440 to update the database with the billing information. The billing manager can, for example, store a purchase entry into the database. The purchase entry can, for example, include a purchase ID, the service subscription ID, the session ID token, and the calculated price.

The billing manager next proceeds to decision block 1442 to determine if any errors occurred as a result of the data insertion, or data update, operation. If an error occurred, the billing manager proceeds to block 1480 to generate an error message and transmit it to the session manager. If no error occurred, the billing manager proceeds to block 1450 to continue processing the bill.

In block 1450, the billing manager retrieves from the database the user information corresponding to the user ID of the source client. The billing manager next proceeds to decision block 1452 to determine if any errors occurred as a result of the data retrieval operation. If an error occurred, the billing manager proceeds to block 1480 to generate an error message and transmit it to the session manager. If no error occurred, the billing manager proceeds to decision block 1454 to continue processing the bill.

In decision block 1454, the billing manager determines if the user account is configured for a prepay billing option. If the user account is not configured for prepayment, the billing manager proceeds to block 1470 and sends an acknowledgement message to the session manager to indicate the billing process successfully completed without errors.

If the user account is configured for the prepayment option, the billing manager proceeds to block 1460 to update the balance in the user account. The billing manager updates the user balance entry in the database by subtracting the calculated price of the video conference session from the current balance.

The billing manager next proceeds to decision block 1462 to determine if any errors occurred as a result of the balance update operation. If an error occurred, the billing manager proceeds to block 1480 to generate an error message and transmit it to the session manager. If no error occurred, the billing manager proceeds to block 1470 and sends an acknowledgement message to the session manager to indicate the billing process successfully completed without errors.

Thus, a video conference system, client devices, and billing and management servers have been disclosed that enable a client device to operate a high quality video conference with another client device. The video conference can use wireless communication links within the network such that the client devices can be portable. The client devices can implement hardware or software codecs to implement multiple video and audio compression algorithms. The network bandwidth which can support, for example, 6 Mbps for a video conference, can support high quality video conference sessions. One client device can simultaneously operate a video conference with one or more remote client devices.

Electrical connections, couplings, and connections have been described with respect to various devices or elements. The connections and couplings can be direct or indirect. A connection between a first and second device can be a direct connection or can be an indirect connection. An indirect connection can include interposed elements that can process the signals from the first device to the second device.

Those of skill in the art will understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Those of skill will further appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present invention.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles defined herein can be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A video conference system configured to provide video conferencing over wireless communication links for portable devices, the system comprising:
a network having wireless access points;
a plurality of client devices in communication with the network, at least one of the plurality of client devices in communication with the network using a wireless communication link to one of the wireless access points, the at least one of the plurality of client devices configured to process a video and audio stream to generate a packetized video and audio stream, the at least one of the plurality of client devices wirelessly transmitting the packetized video and audio stream as video conference session data to the network, the at least one of the plurality of client devices further configured to receive a packetized remote video and audio stream from the network;
a billing system management application (BSMA) server connected to the network and in communication with the at least one of the plurality of client devices, the BSMA server configured to authenticate the plurality of client devices, communicate call requests from a source device to a destination device, initiate a video conference session between the source device and the destination device, and determine a bill for the video conference session between the source device and the destination device.

2. The video conference system of claim 1, wherein the BSMA server comprises an authentication server coupled to the network and configured to receive from the network an authentication request message transmitted by the source client, the authentication server authenticating the source client with the video conference system.

3. The video conference system of claim 1, wherein the BSMA server comprises a session manager configured to manage the video conference session between the source device and the destination device in part, by tracking a duration of an active video conference session between the source device and the destination device.

4. The video conference system of claim 1, wherein the BSMA server comprises a session manager configured to receive an authentication/initialization request from the source device requesting a video conference session with the destination device.

5. The video conference system of claim 4, wherein the authentication/initialization request includes the MAC and IP address of the source client device, and a user ID associated with the destination device and the session manager accesses a database to retrieve an IP address of the destination device, and the session manager transmits the IP address of the destination device to the source device.

6. The video conference system of claim 4, wherein the session manager is configured to generate a random session ID in response to the authentication/initialization request, and the session manager is further configured to transmit the session ID to the source device.

7. The video conference system of claim 4, wherein the session manager is configured to receive a start message from the source device and update a session entry to indicate a session start time.

8. The video conference system of claim 4, wherein the session manager is configured to receive an abort message from the source device and update a session entry to indicate a session abort time.

9. The video conference system of claim 4, wherein the BSMA server further comprises a billing manager, and wherein the session manager is configured to receive a termination message from one of the source device or the destination device, the session manager further configured to update a session entry to indicate a session end time, and transmit a billing request message to the billing manager.

10. The video conference system of claim 1, wherein the BSMA server further comprises a background process configured to periodically access a session entry to determine if a heartbeat signal has been received from the source device within a predetermined period of time.

11. The video conference system of claim 1, wherein the source device is configured to transmit a heartbeat signal during an active video conference session and the BSMA server comprises a heartbeat manager configured to update a heartbeat time stored in a database and transmit a heartbeat acknowledgement message to the source device in response to the heartbeat signal.

12. The video conference system of claim 1, wherein the network is configured to prioritize video conference session data.

13. A video conferencing device for use in a wireless video conferencing system where the video conferencing device communicates with a network over a wireless communication link, the device comprising:
a video encoder configured to receive a video stream and generate an encoded video stream by selectively encoding the video stream using one of a plurality of video encoding algorithms;
a video packetizer coupled to the video encoder and configured to packetize the encoded video stream to generate a packetized video stream;
an audio encoder configured to receive an audio stream and generate an encoded audio stream by encoding the audio stream using an audio encoding algorithm;
an audio packetizer coupled to the audio encoder and configured to packetize the encoded audio stream to generate a packetized audio stream;
a transmit stream controller coupled to the video packetizer and the audio packetizer, the transmit stream controller configured to wirelessly transmit the packetized video stream and packetized audio stream to the network at a rate greater than 2 Mbps for delivery to a destination device in wireless communication with the network.

14. The video conferencing device of claim 13, further comprising a camera coupled to the video encoder, the camera configured to generate the video stream.

15. The video conferencing device of claim 13, further comprising a microphone coupled to the audio encoder, the microphone configured to generate the audio stream.

16. The video conferencing device of claim 13, wherein the plurality of video encoding algorithms comprises H.263+, MPEG-2, MPEG-4, Motion-JPEG, and Motion-JPEG2000.

17. The videoconferencing device of claim 13, wherein the encoder is further configured to encode the video stream with a first encoding algorithm during a first period of time and encode the video stream with a second encoding algorithm during a second period of time.

18. The video conferencing device of claim 13, wherein the transmit stream controller is configured to transmit the packetized video stream and packetized audio stream at a rate greater than 3 Mbps.

19. The video conferencing device of claim 13, wherein the transmit stream controller is configured to transmit the packetized video stream and packetized audio stream at a rate greater than 4 Mbps.

20. The video conferencing device of claim 13, wherein the transmit stream controller is configured to transmit the packetized video stream and packetized audio stream at a rate greater than 5 Mbps.

21. The video conference device of claim 13, wherein the video packetizer is configured to packetize the encoded video stream according to a Real Time Protocol (RTP).

22. The video conference device of claim 13, wherein the video packetizer is configured to packetize the encoded video stream according to a Real Time Protocol (RTP) over a User Datagram Protocol (UDP).

23. The video conference device of claim 13, wherein the video packetizer is configured to packetize the encoded video stream according to a Real Time Protocol (RTP) over a Transmission Control Protocol (TCP).

24. The video conference device of claim 13, wherein the transmit stream controller is configured to wirelessly transmit the packetized video stream and packetized audio stream, via a communication network, to a first destination device.

25. The video conference device of claim 24, wherein the transmit stream controller is further configured to wirelessly transmit the packetized video stream and packetized audio stream, via the communication network, to a second destination device.

26. The video conferencing device of claim 24, further comprising:
a receive stream controller coupled to the transmit stream controller, the receive stream controller configured to receive the packetized video stream and packetized audio stream from the transmit stream controller, the receive stream controller further configured to wirelessly receive, at a rate greater than 2 Mbps, a remote packetized video stream and a remote packetized audio stream;
a video depacketizer connected to the receive stream controller, the video depacketizer configured to depacketize the remote packetized video stream to generate a remote encoded video stream;
a video decoder connected to the video depacketizer, the video decoder configured to decode the remote encoded video stream to generate a decoded remote video stream;
an audio depacketizer connected to the receive stream controller, the audio depacketizer configured to depacketize the remote packetized audio stream to generate a remote encoded audio stream;
an audio decoder connected to the audio depacketizer, the audio decoder configured to decode the remote encoded audio stream to generate a decoded remote audio stream; and
a resynchronizer coupled to the video decoder and audio decoder, the resynchronizer configured to resynchronize the remote decoded video stream to the remote decoded audio stream.

27. The video conferencing device of claim 26, further comprising a display connected to the resynchronizer, the display configured to display the remote decoded video stream.

28. The video conferencing device of claim 26, further comprising a speaker connected to the resynchronizer, the speaker configured to output the remote decoded audio stream.

29. The video conferencing device of claim 26, wherein the video depacketizer is further configured to depacketize the packetized video stream to generate a loopback encoded video stream.

30. The video conference device of claim 26, further comprising a session controller, and wherein the video depacketizer is further configured to determine a rate of dropped packets and communicate the rate of dropped packets to the session controller, the session controller transmitting the rate of dropped packets in a feedback message to a remote destination.

31. A video conference server for managing video conference sessions in a wireless video conference system where each of a plurality of client devices communicates with the video conference server over wireless communication links, the video conference server comprising:
a session manager configured to control initialization and termination of a video conference session between a first client device in wireless communication with a network and a second client device in wireless communication with the network;
a billing manager in communication with the session manager, the billing server configured to determine a bill for the video conference session, following termination of the video conference session between the first client device and the second client device, in response to a billing request message from the session manager;
a database in communication with the session manager and the billing manager, the database configured to store user account data and video conference session entries;
a heartbeat manager in communication with the database, the heartbeat manager configured to receive a heartbeat signal transmitted by a source device engaged in an active video conference session and further configured to update a heartbeat entry in the database in response to receiving the heartbeat signal; and
a session monitor daemon in communication with the session manager, the session monitor daemon configured to periodically determine a status of the heartbeat signal transmitted by the source device.

32. The video conference server of claim 31, wherein the session manager is further configured to receive an initialization request from the source device requesting the video conference session with a destination device, the session manager accesses a database to retrieve an address of the destination device, and transmits the address of the destination device to the source device in response to the initialization request.

33. The video conference server of claim 32, wherein the session manager is further configured to generate a random session ID in response to the initialization request, and the session manager is further configured to transmit the session ID to the source device.

34. The video conference server of claim 31, wherein the session manager is further configured to receive a start message from the source device and update a session entry to indicate a session start time.

35. The video conference server of claim 31, wherein the session manager is further configured to receive an abort message from the source device and update a session entry to indicate a session abort time.

36. The video conference server of claim 31, wherein the session manager is further configured to receive a termination message from the source device and update a session entry to indicate a session end time, and wherein the session manager transmits the billing request message in response to the termination request.

37. The video conference server of claim 31, wherein the billing server determines the bill for the video conference session, in part, on a usage rate associated with the source device.

38. The video conference server of claim 31, wherein the billing server determines the bill for the video conference session, in part, on a duration of the video conference session.

39. The video conference server of claim 31, wherein the billing server determines if a user associated with the source client has enabled a prepayment account, and wherein the billing server deducts a price of the video conference from a balance indicated in the prepayment account.

40. A method of videoconferencing using wireless communication links, the method comprising:
capturing a local video stream;
encoding the local video stream according to a first encoding algorithm;
capturing a local audio stream;
encoding the local audio stream;
generating a local packetized stream comprising the encoded local video stream and encoded local audio stream, both configured according to a Real Time Protocol (RTP);
wirelessly transmitting the local packetized stream;
wirelessly receiving a remote packetized stream comprising an encoded remote video stream and an encoded remote audio stream;
decoding the encoded remote video stream to produce a remote video stream;
decoding the remote audio stream to produce a remote audio stream;
resynchronizing the remote video stream to the remote audio stream;
displaying the remote video stream; and
outputting the remote audio stream.

41. The method of claim 32, further comprising:
decoding the local video stream to produce a loopback video stream; and
displaying the loopback video stream.

42. The method of claim 32, further comprising, prior to receiving the remote packetized stream:
transmitting an authentication/initialization request to a session manager, the authentication/initialization request including a MAC address and IP address of the source client device, and a destination user ID; and
receiving an initialization response from the session manager, the initialization response including a destination user address.

43. The method of claim 34, further comprising:
transmitting a call request to a destination device; and
receiving an acceptance message from the destination device.

44. The method of claim 32, further comprising:
periodically transmitting a heartbeat signal to a heartbeat manager; and
receiving a heartbeat acknowledgement message from the heartbeat manager.

45. The method of claim 36, further comprising ending a video conference session if the heartbeat acknowledgement message is not received within a predetermined period of time.

46. The method of claim 32, wherein the act of capturing a local video stream comprises capturing the local video stream at a rate of 30 frames per second (fps), the local video stream having a resolution of at least 640×480.

47. A method of video conferencing using wireless communication links, the method comprising:
wirelessly receiving from a network access point a call request message transmitted by a remote device;
wirelessly transmitting an acceptance message;
initiating a lecture mode, wherein initiating the lecture mode comprises:
receiving a remote video stream transmitted by the remote device;
receiving a remote audio stream transmitted by the remote device;
displaying the remote video stream;
outputting the remote audio stream; and
inhibiting transmission of a local video stream and a local audio stream.

48. The method of claim 47, further comprising displaying, in a preview window, the remote video stream transmitted by the remote device prior to transmitting the acceptance message.

49. The method of claim 47, further comprising:
inhibiting the lecture mode; and
enabling a conference mode, wherein enabling the conference mode comprises:
receiving the remote video stream transmitted by the remote device;
receiving the remote audio stream transmitted by the remote device;
displaying the remote video stream;
outputting the remote audio stream;
wirelessly transmitting the local video stream; and
wirelessly transmitting the local audio stream.

50. The method of claim 49, further comprising:
receiving a feedback signal from the remote device: and
adjusting a resolution of the local video stream based, at least in part, on the feedback signal.

51. The method of claim 49, wherein wirelessly transmitting the local video stream comprises:
receiving a video stream from a video source;
selectively encoding the video stream with an encoding algorithm from a plurality of encoding algorithms to generate an encoded video stream;
packetizing the encoded video stream to generate a packetized video stream; and
wirelessly transmitting the packetized video stream to the network access point.

52. The method of claim 51, wherein receiving the video stream from the video source comprises receiving the video stream from a camera.

53. The method of claim 51, wherein receiving the video stream from the video source comprises receiving a prerecorded video stream from a playback device.

54. The method of claim 51, wherein receiving the video stream from the video source comprises:
receiving a first video stream from a first video source;
receiving a second video stream from a second video source; and
multiplexing the first video stream with the second video stream.

55. The method of claim 51, wherein receiving the video stream from the video source comprises:
receiving a video signal;
receiving a text signal; and
multiplexing the video signal with the text signal.

56. The method of claim 55, wherein receiving the text signal comprises:
receiving an audio voice signal; and
converting the audio voice signal to the text signal using voice recognition in combination with speech to text conversion.

57. The method of claim 51, wherein selectively encoding the video stream comprises:
encoding the video stream with a first encoding algorithm;
terminating the encoding of the video stream with the first encoding algorithm; and
encoding the video stream with a second encoding algorithm.

58. The method of claim 51, wherein packetizing the encoded video stream comprises packetizing the encoded video stream according to Real Time Protocol (RTP) over User Datagram Protocol (UDP).

59. The method of claim 51, wherein packetizing the encoded video stream comprises packetizing the encoded video stream according to Real Time Protocol (RTP) over Transmission Control Protocol (TCP).

60. The method of claim 49, wherein wirelessly transmitting the local audio stream comprises:
selectively encoding the audio stream with an audio encoding algorithm from a plurality of audio encoding algorithms to generate an encoded audio stream;
packetizing the encoded audio stream to generate a packetized audio stream; and
wireIessly transmitting the packetized audio stream to the network access point.

61. The method of claim 47, further comprising:
determining a signal quality of the remote video stream; and
transmitting a feedback signal, based in part on the signal quality, to the remote device.

62. The method of claim 47, further comprising storing a portion of the received video stream and received audio stream in memory.

63. The method of claim 47, wherein wirelessly transmitting the acceptance message comprises:
determining an address of the remote device;
automatically generating the call acceptance message if the address of the remote device corresponds to a predetermined address; and
wirelessly transmitting the acceptance message.

64. The method of claim 47, further comprising:
receiving an additional video stream from an additional remote device;
receiving an additional audio stream from the additional audio device;
displaying the video stream in a first window; and
displaying the additional video stream in a second window, wherein the second window partially overlaps the first window.

65. The method of claim 64, further comprising:
detecting an audio magnitude of the audio stream;
detecting an audio magnitude of the additional audio stream;
displaying the second window over the first window if the audio magnitude of the additional signal is greater than the audio magnitude of the audio stream.

66. The method of claim 64, further comprising:
assigning a first priority to the audio stream;
assigning a second priority to the additional audio stream; and
displaying the first window and the second window based, in part, on the first and second priority.

67. A method of video conferencing using wireless communication links, the method comprising:
wirelessly receiving from a network access point a call request message transmitted by a remote device;
wirelessly transmitting a rejection message; and
storing in memory a video stream transmitted by the remote device in response to the rejection message.

68. A method of multiple concurrent video conferencing using wireless communication links to a network, the method comprising:
initiating a first video conference session between a first client device, in wireless communication with a first access point of the network, and a second client device in wireless communication with a second access point of the network;
wirelessly transmitting a first packetized video stream from the first client device to the network including an address for delivery to the second client device;
wirelessly receiving, at the first client device, a second packetized video stream from the network, the second packetized video stream transmitted by the second client device;
initiating a second video conference session between the first client device and a third client device in wireless communication with a third access point of the network;
wirelessly transmitting the first packetized video stream from the first client device to the network including an address for delivery to the third client device;
wirelessly receiving a third packetized video stream from the network, the third packetized video stream transmitted by the third client device;
initiating a third video conference session between the second client device and the third client device;
wirelessly transmitting, from the second client device, the second packetized video stream from the second client device to the network including an address for delivery to the third client device;
wirelessly receiving, at the second client device, the third packetized video stream from the network, the third packetized video stream transmitted by the third client device;
